(19) United States
(12) Patent Application Publication
(10) Pub. No.: US 2025/0115427 A1
(43) Pub. Date: Apr. 10, 2025

(54) MASTLESS LIFT AND MATERIAL HANDLING SYSTEM INCLUDING SUCH MASTLESS LIFT

(71) Applicant: Symbotic LLC, Wilmington, MA (US)

(72) Inventors: Richard B. Cohen, Wilmington, MA (US); Cristian Mori, Wilmington, MA (US); Matthew Medford, Wilmington, MA (US)

(21) Appl. No.: 18/905,897

(22) Filed: Oct. 3, 2024

Related U.S. Application Data
(60) Provisional application No. 63/588,532, filed on Oct. 6, 2023.

(51) Int. Cl. B65G 1/04; B66F 9/065

(52) U.S. Cl. CPC B65G 1/0492; B66F 9/065

(57) ABSTRACT

A lift robot including a chassis that defines a lift axis of the robot, the chassis has a frame with a wheel set mounted thereon, each wheel of the wheel set contacts a riding surface of a storage rack structure and supports the robot on the storage rack structure so that robot rides on the storage rack structure throughout a complete range of motion of the robot, and a payload bay connected to the chassis, the payload bay having a payload bed, for holding a payload thereon, the payload bed being disposed angled to the lift axis, wherein the wheel set is configured so as to form a contact interface arranged along a substantially upright plane including the lift axis and the contact interface defines a lift interface engaging the riding surface, and wherein the contact interface is maintained substantially continuously throughout the complete range of motion of the robot.

### CROSS REFERENCE TO RELATED APPLICATIONS

This application is a non-provisional and claims the benefit of U.S. Provisional Patent Application No. 63/588,532, filed on Oct. 6, 2023, the disclosures of which are incorporated herein by reference in their entirety.

### BACKGROUND

### 1. Field

The present disclosure generally relates to material handling systems and, more particularly, to transport of items within the material handling system.

### 2. Brief Description of Related Developments

Generally, automated storage and retrieval systems or generally material handling systems such as in warehouses, distribution facilities, etc. multilevel storage structure having storage spaces into which goods are placed for storage and from which the goods are retrieved for fulfilling orders. The goods are transported to and retrieved from the storage spaces by autonomous vehicles.

Many automated material handling systems use lifts to transport goods from one level of the multilevel storage structure to another level of the multilevel storage structure. To transport goods to storage, the autonomous vehicles generally receive goods from an inbound lift, where the inbound lift, at least in part, transports the goods from a depalletizer cell to a predetermined level of the multilevel storage structure for picking by an autonomous vehicle at the predetermined level. Generally, conveyors transport the goods to inbound lifts and the lifts then transport the goods to the different levels of the multilevel storage structure. Autonomous vehicles pick the goods from the lifts or from buffer stations adjacent the lifts and put the goods into storage. To retrieve goods from storage, the autonomous vehicles at predetermined levels of the multilevel storage structure generally pick goods from storage and transport the retrieved goods to an outbound lift or buffer station adjacent the lifts, where the outbound lift, at least in part, transports the retrieved goods to a conveyor that transports the goods out of the storage structure to a palletizer for placement in an outbound pallet load.

The inbound and outbound lifts are modularized so that each lift includes a respective framework or mast that is placed adjacent the multilevel storage rack structure. A typical lift includes a large steel or aluminum mast with guide tracks for a load handling device. The load handling device rides up and down the mast, under impetus of a belt or rack and pinion, for transport of goods to the different levels of the multilevel storage structure. Generally, the mast is located behind the load handling device such that the load handling device has a very large cantilever load which requires the load handling device and the mast to be very stiff to limit deflection. The required stiffness of the mast and load handling device increases the complexity and cost of the lift.

The masts of conventional lift designs are generally very heavy and typically require a crane for installation of the masts. The lift framework must be aligned with and fastened to the multilevel storage rack structure for proper transfer of goods to and from the different levels of the multilevel storage structure, which may be a tedious and time consuming process. In addition, the framework of each lift occupies valuable floor space and increases costs of the storage structure due to material acquisition for and construction of the lift framework. The lifts are also controlled like a piece of industrial equipment, which is also expensive, and generally require pits in the floor of the facility in which they operate to reach the lowest levels of the multilevel storage structure.

It would be advantageous to provide a lift having a simplified structure that is installed in less time than conventional modular inbound/outbound lifts.

### BRIEF DESCRIPTION OF THE DRAWINGS

The foregoing aspects and other features of the present disclosure are explained in the following description, taken in connection with the accompanying drawings, wherein:

FIG. 1 is a schematic illustration of an automated material handling system in accordance with aspects of the present disclosure;

FIGS. 1A and 1B are schematic illustrations of portions of the automated material handling system of FIG. 1 in accordance with aspects of the present disclosure;

FIG. 1C is a schematic illustration of a mixed pallet load formed by the automated material handling system of FIG. 1 in accordance with aspects of the present disclosure;

FIG. 1D is a schematic illustration of a portion of the automated material handling system of FIG. 1 in accordance with aspects of the present disclosure;

FIG. 2A is a schematic illustration of a portion of the material handling system of FIG. 1 in accordance with aspects of the present disclosure;

FIG. 2B is a schematic illustration of a portion of the material handling system of FIG. 1 in accordance with aspects of the present disclosure;

FIG. 3A is a schematic perspective illustration a portion of a lift employed in the automated material handling system of FIG. 1 in accordance with aspects of the present disclosure;

FIGS. 3B-3F are schematic illustrations of portions of the lift illustrated in FIG. 3A in accordance with aspects of the present disclosure;

FIG. 3G is an exemplary force diagram for a portion of the lift illustrated in FIG. 3A in accordance with aspects of the present disclosure;

FIG. 3H is a schematic perspective illustration a portion of a lift employed in the automated material handling system of FIG. 1 in accordance with aspects of the present disclosure;

FIG. 3I is a schematic perspective illustration a portion of a lift employed in the automated material handling system of FIG. 1 in accordance with aspects of the present disclosure;

FIGS. 3J and 3K are schematic illustrations of portions of the lift illustrated in FIG. 3I in accordance with aspects of the present disclosure;

FIGS. 4A-4F are schematic illustrations of portions of a drive system of the lifts described herein in accordance with aspects of the present disclosure;

FIGS. 5A and 5B collectively are a schematic illustration of the lifts described herein in accordance with aspects of the present disclosure;

FIG. 5C is a schematic illustration of the lifts described herein in accordance with aspects of the present disclosure;

FIG. 5D is an exemplary lift arrangement in accordance with aspects of the present disclosure;

FIGS. 6A-6E collectively illustrate an exemplary pick or place sequence of the lifts described herein in accordance with aspects of the present disclosure;

FIGS. 6F-6H are exemplary schematic illustrations of the lifts described herein in various stages of extension in accordance with aspects of the present disclosure;

FIGS. 7A and 7B are exemplary schematic illustrations of an end effector of the lifts described herein, in various stages of extension, in accordance with aspects of the present disclosure; and

FIGS. 8-10 are exemplary flow diagrams of methods in accordance with aspects of the present disclosure.

### DETAILED DESCRIPTION

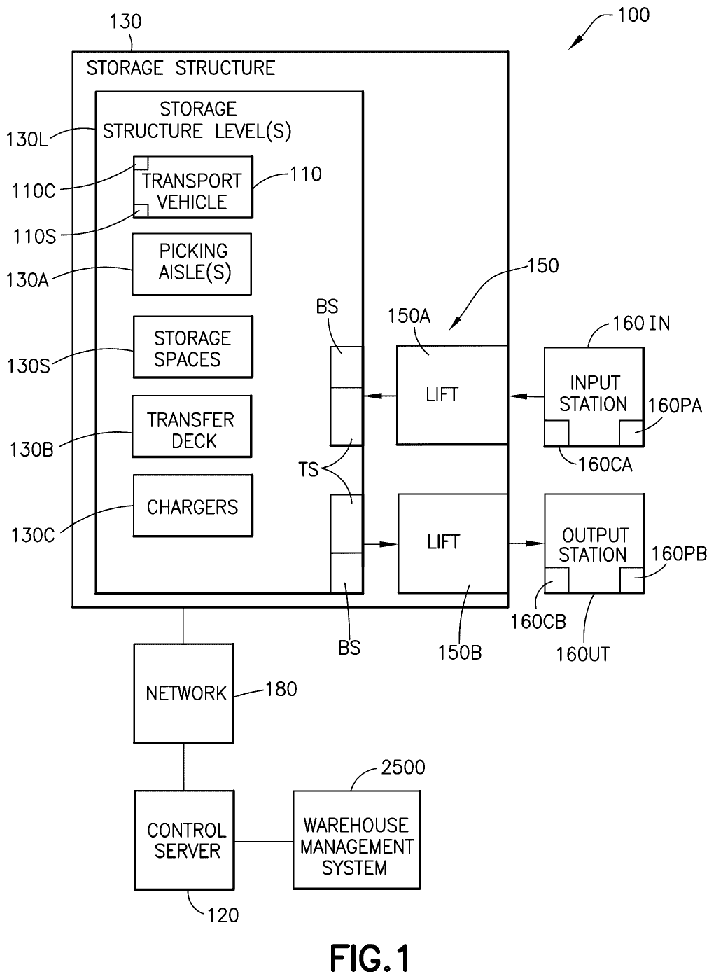

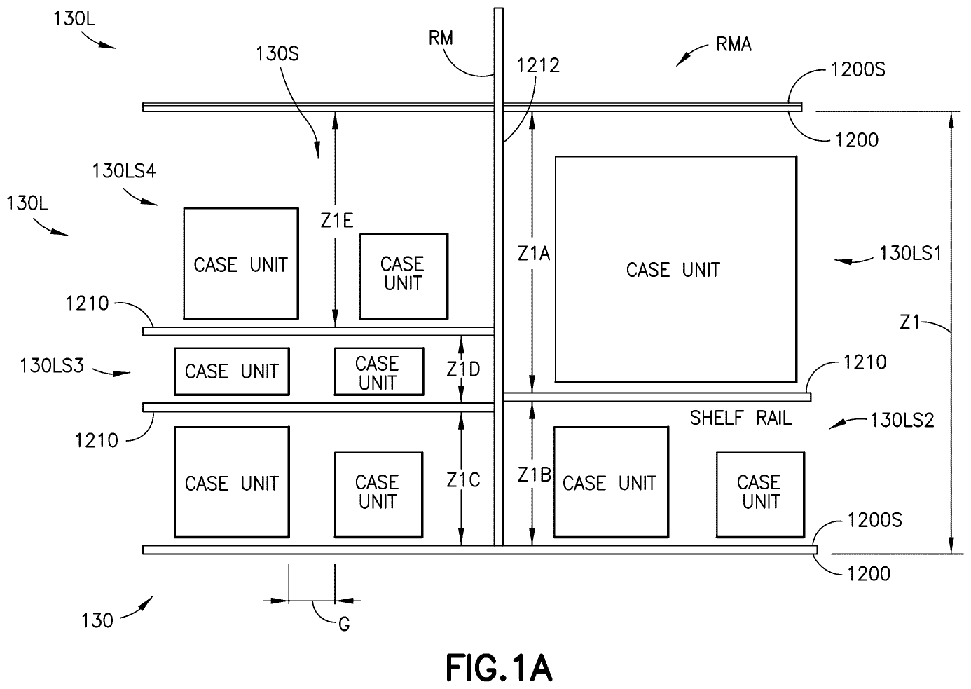

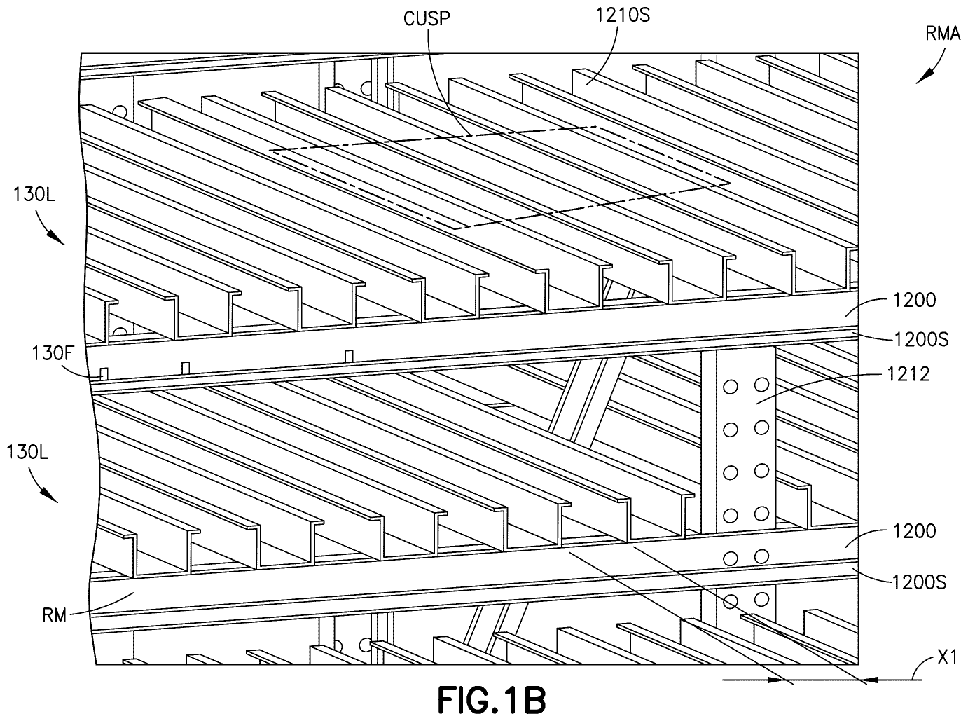

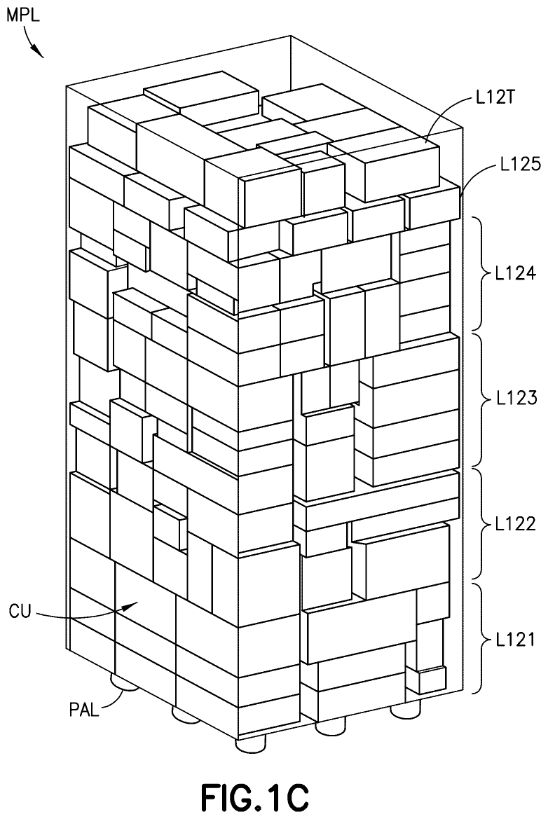

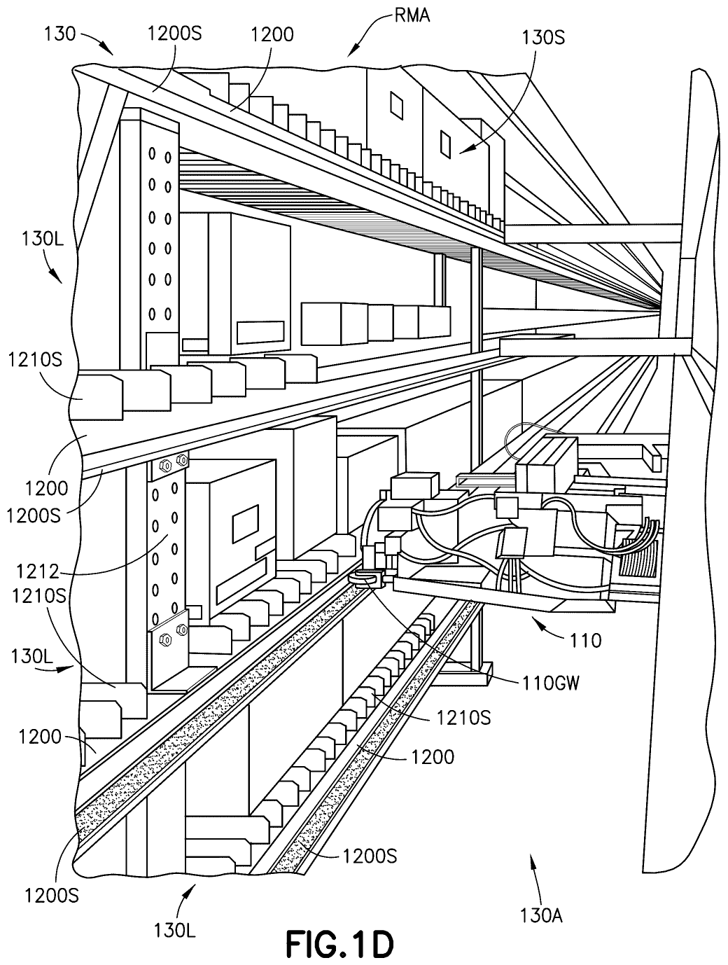

FIG. 1 is a schematic illustration of an automated storage and retrieval system or automated material handling system 100 that includes a storage or storage rack structure 130 and one or more lifts 150 in accordance with aspects of the present disclosure. Although the aspects of the present disclosure will be described with reference to the drawings, it should be understood that the aspects of the present disclosure can be embodied in many forms. In addition, any suitable size, shape or type of elements or materials could be used.

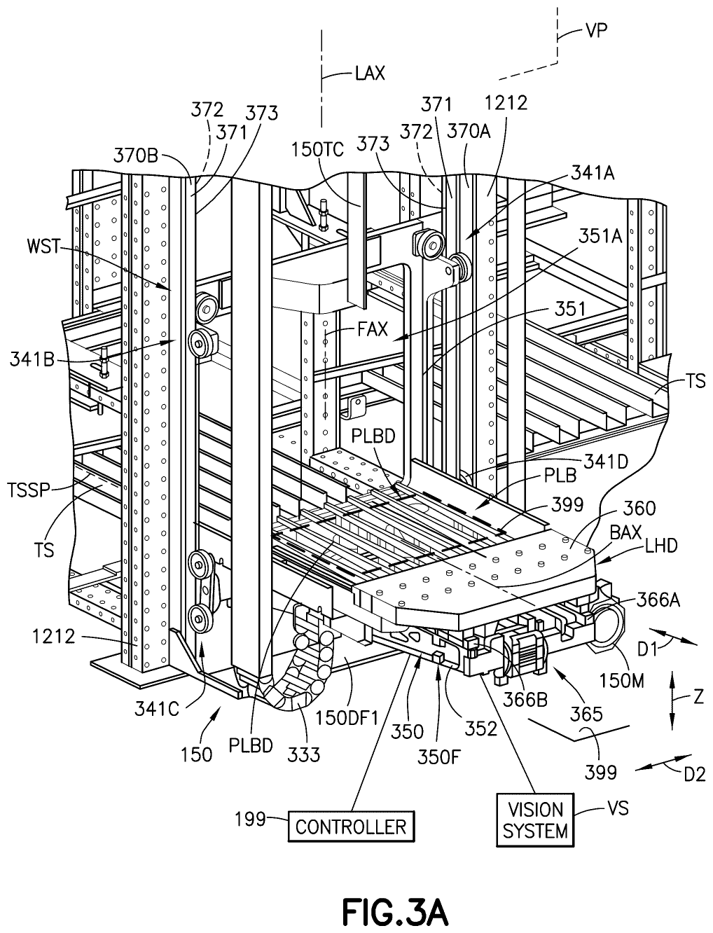

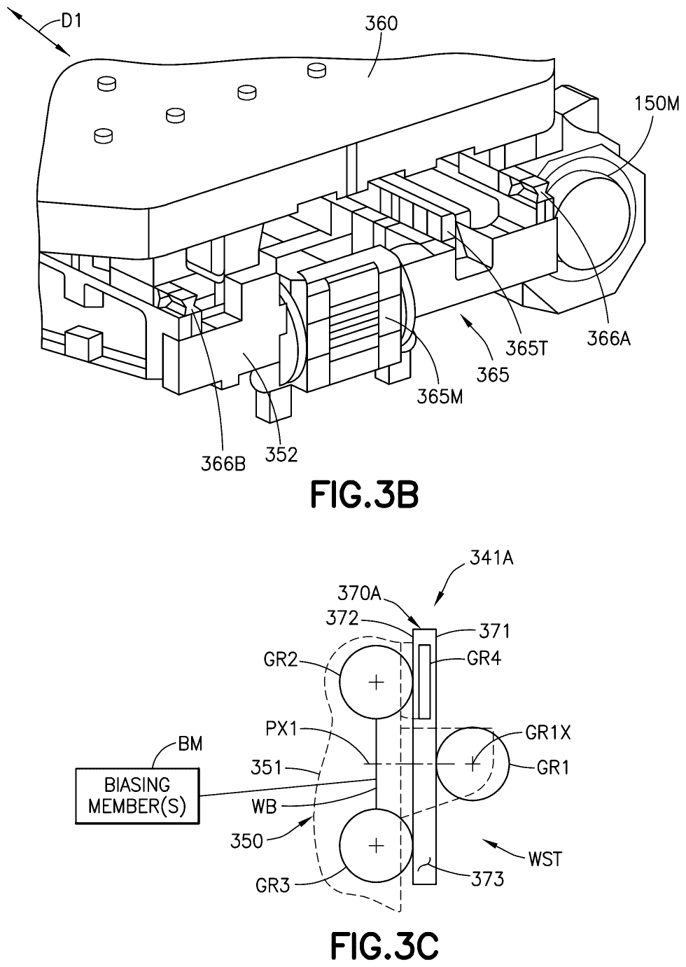

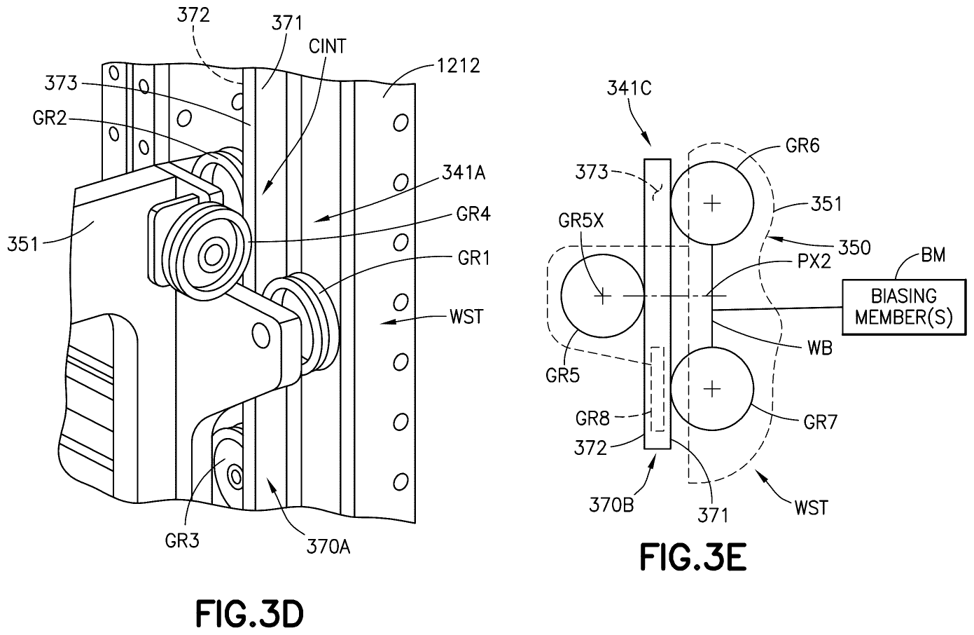

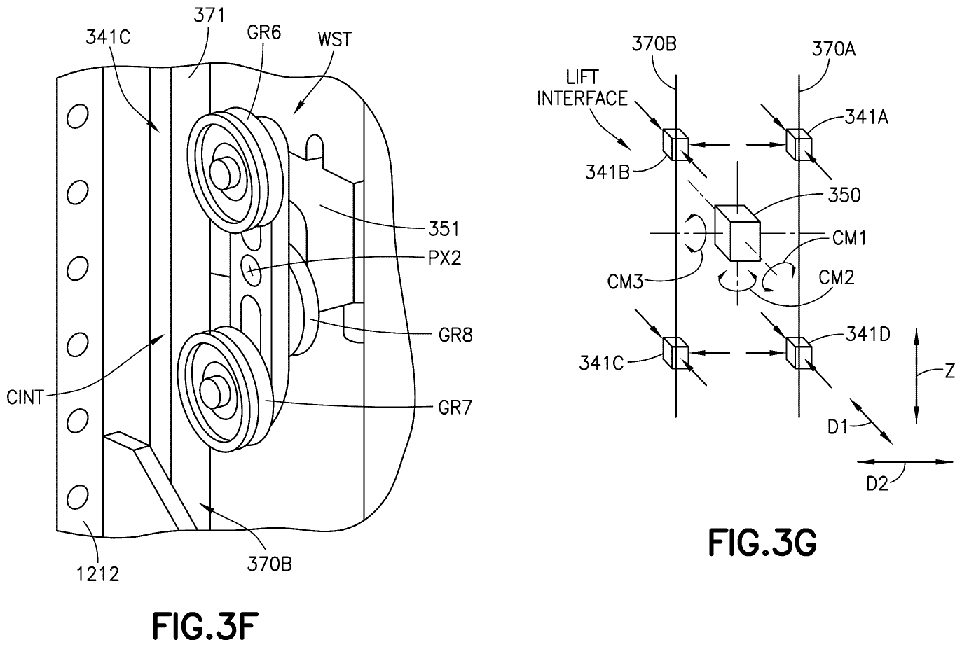

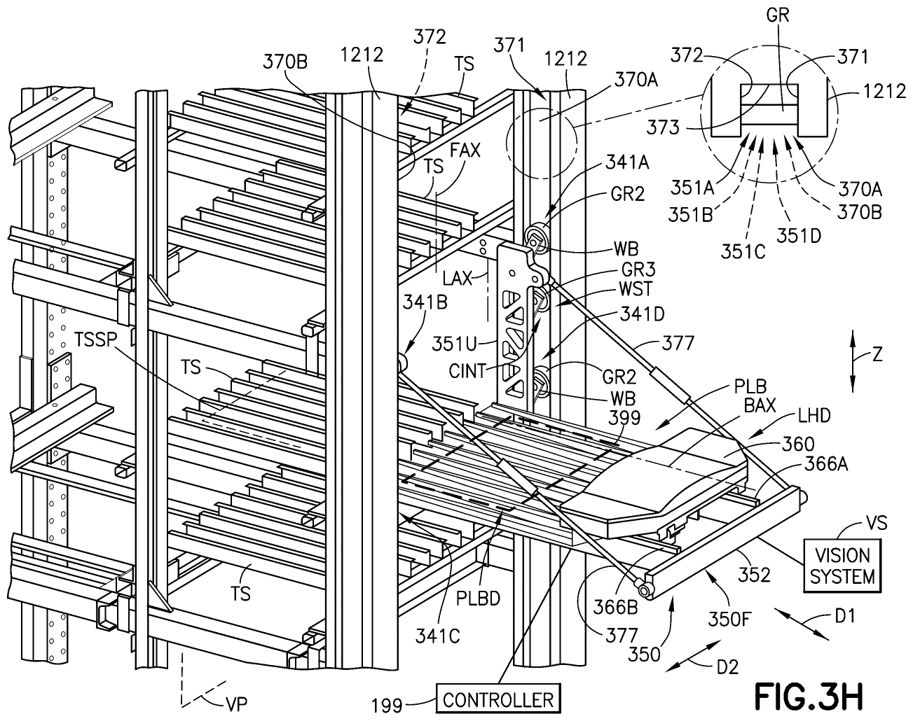

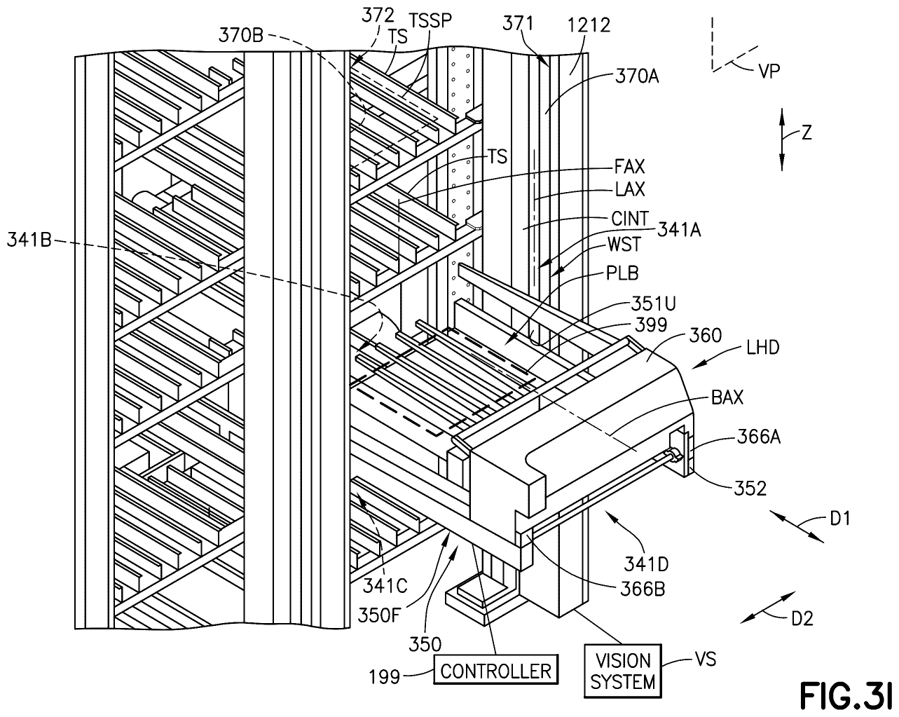

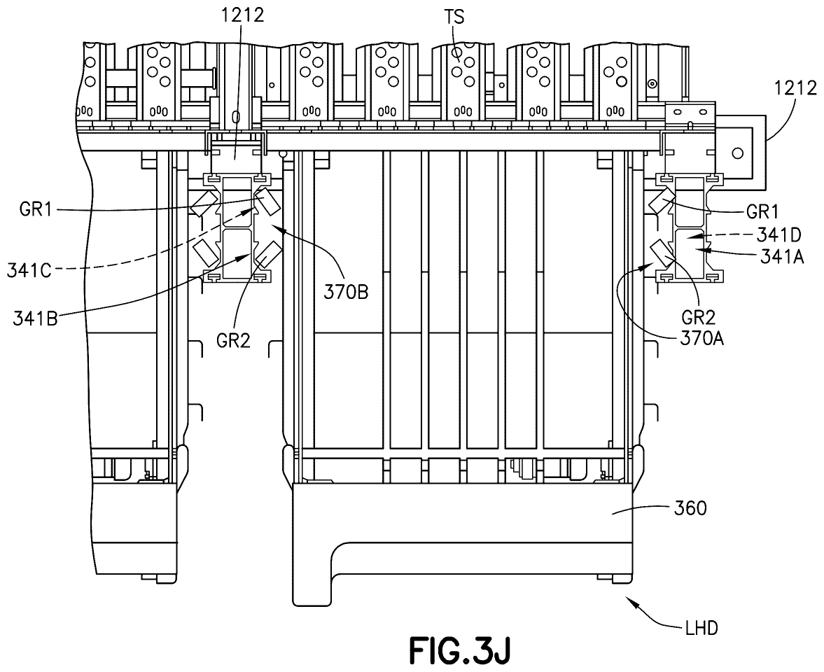

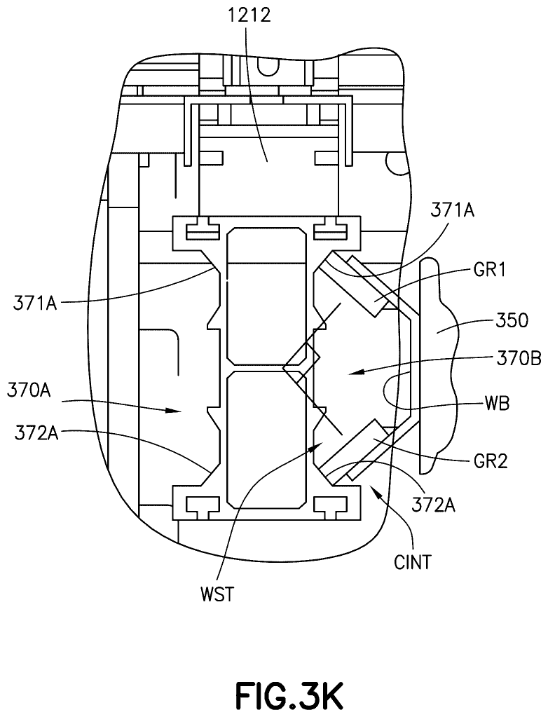

The aspects of the present disclosure provide for the employment of one or more lifts 150 in the automated material handling system 100 where the load handling devices or lift robots LHD of the lifts 150 (see also, e.g., FIGS. 3A, 3H, and 3I) move case units CU in the vertical or Z direction to and from different levels 130L of the material handling system 100 storage structure 130. The load handling devices LHD of the lifts 150 travel vertically on guide rails or tracks 370A, 370B (see, e.g., FIGS. 3A, 3H, and 3I) that are directly coupled to or otherwise integral with the storage structure 130 such that the lift 150 does not have a mast (i.e., the lift is a mastless lift); however, in other aspects the load handling devices LHD of the lifts 150 may be coupled to a dedicated lift mast, where the load handling devices LHD are disposed on one side of the lift mast (i.e., facing a single common direction) or on opposing sides of the lift mast (i.e., facing away from each other in opposing directions). The load handling devices LHD 150 each have an end effector 360 that extends and retracts in direction D1 (i.e., horizontally or transverse to the Z direction) underneath one or more case units CU to transfer the one or more case units between the storage structure 130 or inbound/outbound conveyor 160CA, 160CB and the lift 150.

As will be described herein, the one or more lifts 150 are integrated into the storage structure 130 and leverage the storage structure 130 components for load handling unit LHD transport guidance to and from the different storage levels 130L of the storage structure 130. Here, the load handling units LHD of the one or more lifts 150 travel along vertical support members 1212 (see, e.g., FIG. 3A) of the storage structure 130, rather than on a conventional lift mast that is separate and distinct from the storage structure and merely coupled thereto. Integration of the one or more lifts 150 into the storage structure 130 may simplify the lift structure (e.g., eliminates mast structure along which the load handling device travels), may reduce the installation time of the lift (e.g., eliminates the coupling of and alignment of the mast structure with the storage structure), reduce the floor space occupied by the lift, and reduce the overall cost of the material handling system 100 compared to a material handling system having a conventional mast structure on and along which a load handling device traverses.

The lifts 150 described herein are akin to a vertically travelling robot than a piece of industrial equipment. As such, the lifts 150 may be controlled in a similar manner to autonomous transport vehicles or bots 110 that traverse respective levels 130L of the storage structure 130. For example, the load handling devices may include any suitable vision system VS (see FIGS. 3A, 3H, and 3I) configured to identify and localize case units CU and/or case unit support structure (e.g., such as transfer or buffer stations TS, BS) disposed at the different storage levels 130L. The vision system VS may include any suitable sensors including, but not limited to, binocular cameras, time of flight cameras, sonar, or any other suitable sensors configured to identify and localize the case units and or case unit support surfaces (and structure thereof) (i.e., in a manner substantially similar to that described in U.S. provisional patent application Nos. 63/377,271 filed on Sep. 27, 2022 titled “Logistics Autonomous Vehicle with Robust Object Detection, Localization and Monitoring” and 63/383,597 filed on Nov. 14, 2022 titled “Logistics Autonomous Vehicle with Robust Object Detection, Localization and Monitoring” and U.S. patent application Ser. No. 17/804,026 filed on May 25, 2022 titled “Autonomous Transport Vehicle with Vision System,” the disclosures of which are incorporated herein by reference in their entireties) for effecting (under control of controller 199) positioning the load handling device LHD relative to the case unit CU and/or case unit support surface and transferring the case unit CU between the load handling device LHD and case unit support surface as described herein.

The load handling devices LHD of the lifts 150 may also have common (i.e., interchangeable) parts with the bots 110 (such as, at least, the end effector 360 and end effector drive system) which lowers costs of the automated material handling system 100 and provides common assemblies between the bots 110 and at least the load handling devices LHD of the lifts 150. Here, the aspects of the present disclosure provide for lifts 150 that do not have a heavy/bulky mast, do not require a crane to install, are less expensive than conventional lifts with masts, lack long cantilevered loads, do not require pits to reach the lowest storage level 130L, can be easily replaced and/or reconfigured to handle different sized case units (e.g., as only the load handling device LHD need be removed/reconfigured), and do not require additional support structure (other than guide rails or tracks 370A, 370B). The guide rails or tracks 370A, 370B can be coupled to or integral with (i.e., preassembled to) the storage structure 130 (such as with the vertical support members 1212) such that installation of the vertical support members 1212 inherently installs the guide rails or tracks 370A, 370B saving installation time and costs.

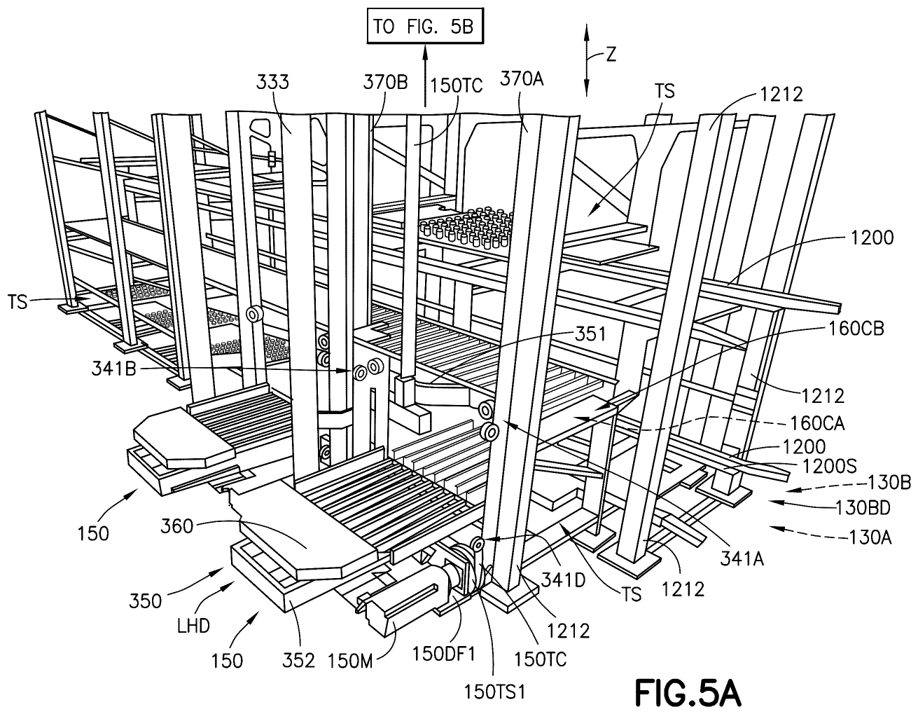

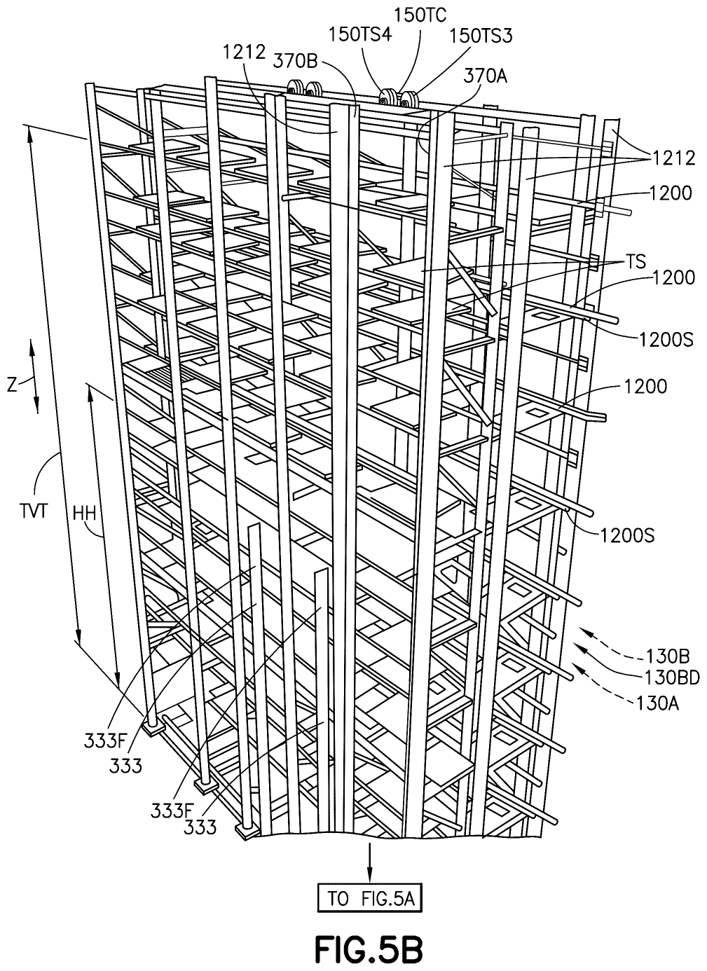

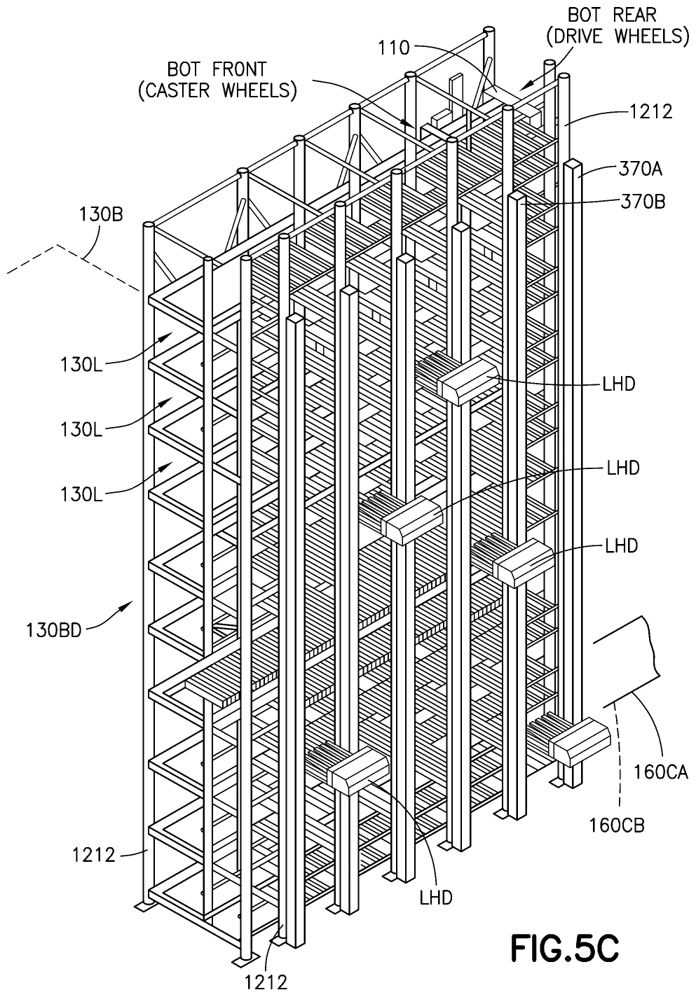

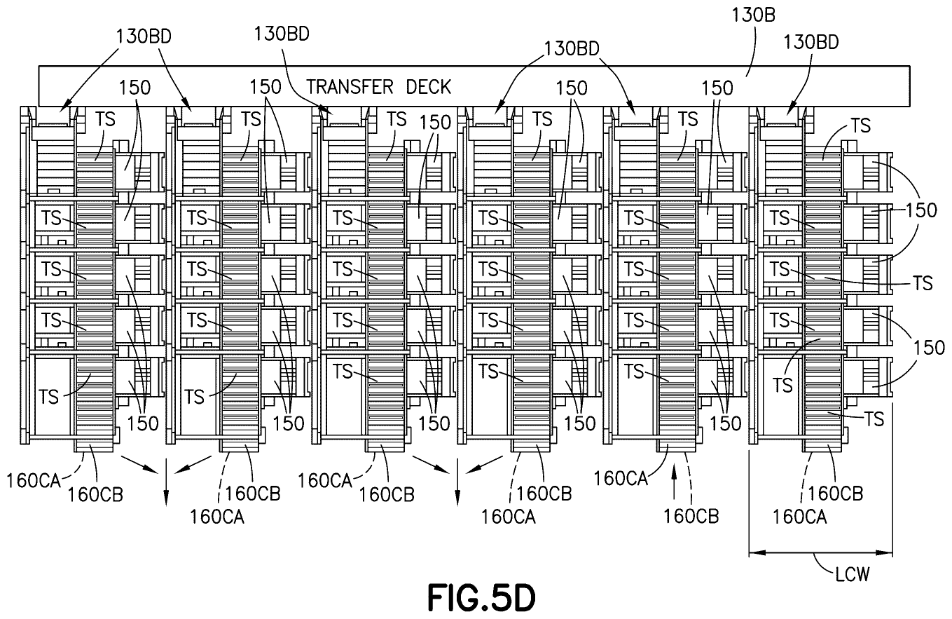

The aspects of the present disclosure may also provide for uniform layouts of the portion of the storage structure 130 (e.g., such as driveways 130BD) again simplifying and reducing costs of the storage structure 130. For example, in conventional material handling systems the driveways are mirrored on either side of a lift mast, whereas in the aspects of the present disclosure, the driveways 130BD may simply be provided in repeating patterns (e.g., facing the same way-see FIG. 5D) of lifts 150, buffer/transfer shelves BS, TS and driveways 130BD that are not mirrored relative to each other. The uniformity of the driveways 130BD may provide for: small lift cell width LCW (e.g., compared to conventional lift cells that require space for a lift mast and access to the lift mast on opposite sides of the lift mast), inbound and outbound lift cells having identical structure, lower cost for parts and installation due to all parts being identical from lift cell to lift cell, easy configuration of the lift cells to fit customer facilities (e.g., compared to lift cells with masts that require access from both sides of the masts), consistent human/operator access to the lift cells that is independent of how the lift cells are arranged, and the bots 110 may back into the driveways 130BD (with drive wheels leading the direction of travel and caster wheels trailing the direction of travel-see FIG. 5C) which backing in requires less space and time than driving into the driveways 130BD in the forward direction (with drive wheels trailing the direction of travel and caster wheels leading the direction of travel).

In accordance with aspects of the present disclosure the automated material handling system 100 may operate in a retail distribution center or warehouse to, for example, fulfill orders received from retail stores for case units such as those described in U.S. Pat. No. 10,822,168 issued on Nov. 3, 2020, the disclosure of which is incorporated by reference herein in its entirety. For example, the case units are cases or units of goods not stored in trays, on totes or on pallets (e.g. uncontained). In other examples, the case units are cases or units of goods that are contained in any suitable manner such as in trays, on totes or on pallets. In still other examples, the case units are a combination of uncontained and contained items. It is noted that the case units, for example, include cased units of goods (e.g. case of soup cans, boxes of cereal, etc.) or individual goods that are adapted to be taken off of or placed on a pallet. In accordance with the aspects of the present disclosure, shipping cases for case units (e.g. cartons, barrels, boxes, crates, jugs, or any other suitable device for holding case units) may have variable sizes and may be used to hold case units in shipping and may be configured so they are capable of being palletized for shipping. It is noted that when, for example, bundles or pallets of case units arrive at the material handling system the content of each pallet may be uniform (e.g. each pallet holds a predetermined number of the same item-one pallet holds soup and another pallet holds cereal) and as pallets leave the material handling system the pallets may contain any suitable number and combination of different case units (e.g. a mixed pallet where each mixed pallet holds different types of case units-a pallet holds a combination of soup and cereal) that are provided to, for example the palletizer in a sorted arrangement for forming the mixed pallet. In the aspects of the present disclosure the material handling system 100 described herein may be applied to any environment in which case units are stored and retrieved.

Also referring to FIG. 1C, it is noted that when, for example, incoming bundles or pallets (e.g. from manufacturers or suppliers of case units arrive at the material handling system for replenishment of the automated material handling system 100, the content of each pallet may be uniform (e.g. each pallet holds a predetermined number of the same item-one pallet holds soup and another pallet holds cereal). As may be realized, the cases of such pallet load may be substantially similar or in other words, homogenous cases (e.g. similar dimensions), and may have the same SKU (Stock Keeping Unit) (otherwise, as noted before the pallets may be “rainbow” pallets having layers formed of homogeneous cases). As pallets PAL (or suitable outbound loads such as unpalletized trailer or truck loads) leave the material handling system 100, with cases filling replenishment orders, the pallets PAL may contain any suitable number and combination of different case units CU (e.g. each pallet may hold different types of case units-a pallet holds a combination of canned soup, cereal, beverage packs, cosmetics and household cleaners). The cases combined onto a single pallet may have different dimensions and/or different SKU's. In one aspect of the present disclosure, the material handling system 100 may be configured to generally include an in-feed section, a storage and sortation section (where, in one aspect, storage of items is optional) and an output section as will be described in greater detail below. As may be realized, the material handling system 100 operating for example as a retail distribution center may serve to receive uniform pallet loads of cases, breakdown the pallet goods or disassociate the cases from the uniform pallet loads into independent case units handled individually by the system, retrieve and sort the different cases sought by each order into corresponding groups, and transport and assemble the corresponding groups of cases into what may be referred to as mixed case loads MPL (illustrated in FIG. 1C as a pallet load for example purposes, though the outbound loads of mixed cases may be assembled in similar fashion but without the pallet, such as with a truck fill). The in-feed section may generally be capable of resolving the uniform pallet loads to individual cases, and transporting the cases via suitable transport, for input to the storage and sortation section (also individual or unpalletized cases may be received such as product returns). The storage and sortation section in one aspect receives individual cases, stores them in a storage area (for example, in a random access storage area) and retrieves (for example, with high speed transport(s) configured for random access to the storage area as described further below) desired cases individually, or in groups, in accordance with commands generated in accordance to orders entered into a warehouse management system, such as warehouse management system 2500, for transport to the output section. In other aspects, the storage and sortation section receives individual cases, sorts the individual cases (utilizing, for example, the buffer stations BS and interface stations TS described herein) and transfers the individual cases (singly or in groups) to the output section in accordance to orders entered into the warehouse management system. The sorting and grouping of cases according to order (e.g. an order out sequence) may be performed in whole or in part by either the storage and retrieval section or the output section, or both, the boundary between being one of convenience for the description and the sorting and grouping being capable of being performed any number of ways. The intended result is that the output section assembles the appropriate group of ordered cases, that may be different in SKU, dimensions, etc. into mixed case pallet loads in the manner described in, for example, U.S. Pat. No. 8,965,559 issued on Feb. 24, 2015, the disclosure of which is incorporated herein by reference in its entirety.

In accordance with aspects of the present disclosure, referring again to FIG. 1, the automated material handling system 100 includes input stations 160IN, output stations 160UT, the one or more lifts 150, the storage structure 130, and a number of autonomous transport vehicles 110 (referred to herein as “bots”). The input stations 160IN include depalletizers 160PA and/or conveyors 160CA for transporting items to one or more lifts, generally referred to as lift(s) 150, for entry into storage. The output stations 160UT include palletizers 160PB and/or conveyors 160CB for transporting case units from one or more lift(s) 150 for removal from storage. The lifts 150 include one or more input lifts 150A and one or more output lifts 150B, noting that while input and output lifts 150A, 150B are shown, a single lift 150 may be used to both input and remove case units to and from the storage structure 130. As used herein the one or more lifts 150, storage structure 130 and bots 110 may be collectively referred to herein as the storage and sorting section noted above for placing pickfaces in storage and outputting pickfaces in a predetermined ordered sequence. It is also noted that the depalletizers 160PA may be configured to remove case units from pallets so that the input station 160IN can transport the items to the one or more lifts 150 for input into the storage structure 130. The palletizers 160PB may be configured to place items removed from the storage structure 130 on pallets PAL (FIG. 1C) for shipping.

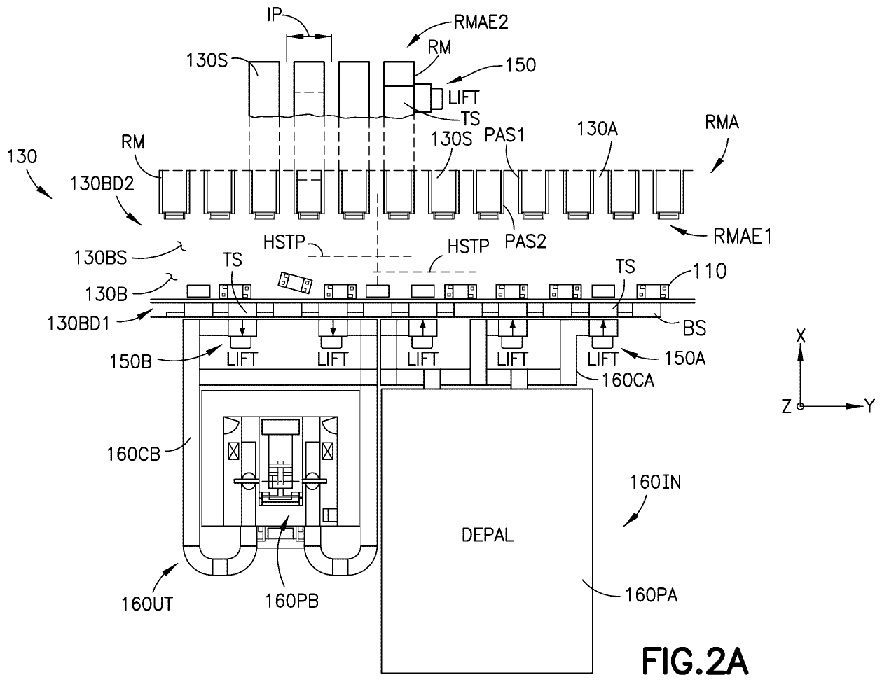

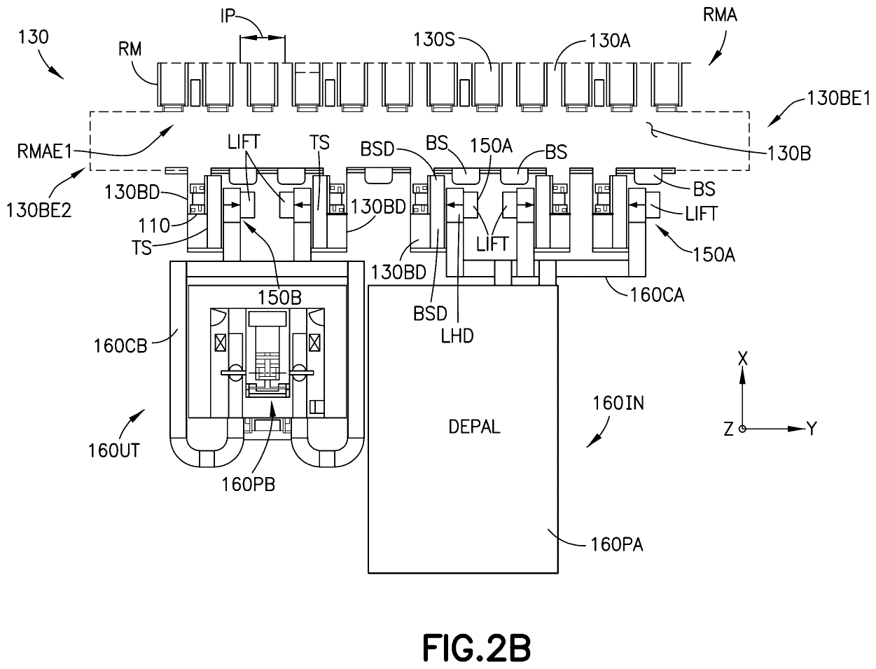

Also referring to FIGS. 2A and 2B, the storage structure 130 includes multiple storage rack modules RM, configured in a three dimensional array RMA, that are accessible by storage or deck levels 130L. Each storage level 130L includes pickface storage/handoff spaces 130S (referred to herein as storage spaces 130S) formed by the rack modules RM where the rack modules RM include shelves (see also FIGS. 1A, 1B, and 1D) that are disposed along storage or picking aisles 130A which, e.g., extend linearly through the rack module array RMA and provide access to the storage spaces 130S and transfer deck(s) 130B over which the bots 110 travel on a respective storage level 130L for transferring case units between any of the storage spaces 130S of the storage structure 130 (e.g. on the level which the bot 110 is located) and any of the lifts 150 (e.g. each of the bots 110 has access to each storage space 130S on a respective level and each lift 150 on a respective storage level 130L). The transfer decks 130B are arranged at different levels (corresponding to each level 130L of the material handling system) that may be stacked one over the other or horizontally offset, such as having one transfer deck 130B at one end or side RMAE1 of the storage rack array RMA or at several ends or sides RMAE1, RMAE2 of the storage rack array RMA as described in, for example, U.S. Pat. No. 10,822,168 issued on Nov. 3, 2020, the disclosure of which is incorporated herein by reference in its entirety.

The transfer decks 130B have a substantially open undeterministic bot travel surface (e.g., a substantially flat surface that does not have physical constraints guiding movement of the bots 110 along the substantially flat surface) that is configured for the undeterministic (e.g., free or not physically constrained) traversal (e.g. travel) of bots 110 across and along the transfer decks 130B. As may be realized, the transfer deck(s) 130B at each storage level 130L communicate with each of the picking aisles 130A on the respective storage level 130L. Bots 110 bi-directionally traverse between the transfer deck(s) 130B and picking aisles 130A on each respective storage level 130L to access the storage spaces 130S disposed in the rack shelves alongside each of the picking aisles 130A (e.g. bots 110 may access storage spaces 130S distributed on both sides of each aisle such that the bot 110 may have a different facing when traversing each picking aisle 130A, for example, referring to FIG. 5, drive wheels 202 leading a direction of travel or drive wheels trailing a direction of travel). As noted above, the transfer deck(s) 130B also provide bot 110 access to each of the lifts 150 on the respective storage level 130L where the lifts 150 feed and remove case units to and/or from each storage level 130L and where the bots 110 effect case unit transfer between the lifts 150 and the storage spaces 130S. As described above, referring also to FIG. 2A, in one aspect the storage structure 130 includes multiple storage rack modules RM, configured in a three dimensional array RMA where the racks are arranged in aisles 130A, the aisles 130A being configured for bot 110 travel within the aisles 130A. As described above, the transfer deck 130B has an undeterministic transport surface on which the bots 100 travel where the undeterministic transport surface 130BS has more than one juxtaposed travel direction or lane HSTP connecting the aisles 130A. As may be realized, the juxtaposed travel lanes (the terms “travel lane” and “direction” may be used interchangeably herein) are juxtaposed along a common undeterministic transport surface 130BS between opposing sides 130BD1, 130BD2 of the transfer deck 130B.

As illustrated in FIGS. 2A and 2B, in one aspect the aisles 130A are joined to the transfer deck 130B on one side 130BD2 of the transfer deck 130B but in other aspects, the aisles are joined to more than one side 130BD1, 130BD2 of the transfer deck 130B in a manner substantially similar to that described in U.S. Pat. No. 10,822,168 issued on Nov. 3, 2020, the disclosure of which is previously incorporated by reference herein in its entirety. In one aspect, the other side 130BD1 of the transfer deck 130B includes deck storage racks (e.g. interface stations TS and buffer stations BS) and/or driveways 130BD (along which interface stations TS and/or buffer stations BS are located) that are distributed along the other side 130BD1 of the transfer deck 130B so that at least one part of the transfer deck 130B is interposed between the deck storage racks and the aisles 130A. The deck storage racks are arranged along the other side 130BD1 of the transfer deck 130B so that the deck storage racks communicate with the bots 110 from the transfer deck 130B and with the lifts 150 (e.g. the deck storage racks are accessed by the bots 110 from the transfer deck 130B and by the lifts 150 for picking and placing pickfaces so that pickfaces are transferred between the bots 110 and the deck storage racks and between the deck storage racks and the lifts 150 and hence between the bots 110 and the lifts 150).

In one aspect a pitch IP (FIGS. 2A and 2B) between aisles 130A or a position of the aisles on the transfer deck 130B is decoupled from a spacing between lift interface stations TS (see FIG. 2A) or a position of the lift interface stations TS (or driveways 130BD-see FIG. 2B) on the transfer deck 130B. For example, in one aspect, the aisles 130A are spaced apart from each other along the transfer deck 130B to effect a maximum, high-density storage while the transfer stations TS (or driveways 130BD) are spaced apart from each other to effect an optimal flow of case units into and out of the storage structure 130. The decoupled spacing of the aisles 130A and the transfer stations TS (or driveways 130BD) is effected by the bot 110 navigation system, in a manner similar to that described in U.S. Pat. No. 11,117,743 issued on Sep. 14, 2021, the disclosure of which is incorporated herein by reference in its entirety, where the bot 110 undeterministically navigates the transfer deck 130B substantially free of guidance constraints and at high speed.

Each storage level 130L may also include charging stations 130C for charging an on-board power supply of the bots 110 on that storage level 130L such as described in, for example, U.S. Pat. No. 11,565,598 issued on Jan. 31, 2023 and U.S. Pat. No. 9,082,112 issued on Jul. 14, 2015, the disclosures of which are incorporated herein by reference in their entireties.

The bots 110, lifts 150 and other suitable features of the material handling system 100 are controlled in any suitable manner such as by, for example, one or more central system control computers (e.g. control server) 120 through, for example, any suitable network 180. In one aspect, the network 180 is a wired network, a wireless network, or a combination of wireless and wired networks using any suitable type and/or number of communication protocols. In one aspect, the control server 120 includes a collection of substantially concurrently running programs (e.g. system management software in the form of non-transitory computer program code) for substantially automatic control of the automated material handling system 100. The collection of substantially concurrently running programs, for example, being configured to manage the material handling system 100 including, for exemplary purposes only, controlling, scheduling, and monitoring the activities of all active system components, managing inventory (e.g. which case units are input and removed, the order in which the cases are removed and where the case units are stored) and pickfaces (e.g. one or more case units that are movable as a unit and handled as a unit by components of the material handling system), and interfacing with a warehouse management system 2500. For simplicity and ease of explanation the term “case unit(s)” is generally used herein for referring to both individual case units and pickfaces (a pickface is formed of one or multiple case units that are moved as a unit).

Referring also to FIGS. 1A, 1B, and 1C the rack module array RMA of the storage structure 130 includes vertical support members 1212 and horizontal support members 1200 that define a high-density automated storage array as will be described in greater detail below. Rails 1200S may be mounted to one or more of the vertical and horizontal support members 1212, 1200 in, for example, picking or rack aisles 130A and be configured so that the bots 110 ride along the rails 1200S through the picking aisles 130A. At least one side of at least one of the picking aisles 130A of at least one storage level 130L may have one or more storage shelves (e.g. formed by rails 1210, 1200 and ribs 1210S) provided at differing heights so as to form multiple shelf levels 130LS1-130LS4 between the storage or deck levels 130L defined by the transfer decks 130B (and the rails 1200S which form an aisle deck). Accordingly, there are multiple rack shelf levels 130LS1-130LS4, corresponding to each storage level 130L, extending along one or more picking aisles 130A communicating with the transfer deck 130B of the respective storage level 130L. As may be realized, the multiple rack shelf levels 130LS1-130LS4 effect each storage level 130L having stacks of stored case units (or case layers) that are accessible from a common deck 1200S of respective storage level 130L (e.g. the stacks of stored cases are located between storage levels).

As may be realized, bots 110 traversing a picking aisle 130A, at a corresponding storage level 130L, have access (e.g. for picking and placing case units) to each storage space 130S that is available on each shelf level 130LS1-130LS4, where each shelf level 130LS1-130LS4 is located between the storage levels 130L on one or more side(s) PAS1, PAS2 (see e.g. FIG. 2A) of the picking aisle 130A.

As noted above, each of the storage shelf levels 130LS1-130LS4 is accessible by the bot 110 from the rails 1200S (e.g. from a common picking aisle deck 1200S that corresponds with a transfer deck 130B on a respective storage level 130L). As can be seen in FIGS. 1A and 1B there are one or more shelf rails 1210 vertically spaced (e.g. in the Z direction) from one another to form multiple stacked storage spaces 130S each being accessible by the bot 110 from the common rails 1200S. As may be realized, the horizontal support members 1200 also form shelf rails (in addition to shelf rails 1210) on which case units are placed.

It is noted that the transfer deck 130B includes vertical and horizontal supports 1212, 1200 in a manner similar to that illustrated in FIGS. 1A, 1B, and 1D, where the horizontal supports 1200 support the transfer decks 130B at respective levels of the picking aisle rails 1200S (e.g., so that the bot 110 traverses between the picking aisle rails 1200S and the transfer deck 130B at a respective storage level 130L of the storage structure 130). The driveways 130BD may be substantially similar to the picking aisles 130A and include horizontal supports 1212, 1200, where the rails 1200S are coupled to the horizontal supports 1200 at respective levels 130L so that the bot 110 traverses between the transfer deck 130B (at the respective level 130L) and the rails 1200S of the driveway 130BD; while in other aspects the horizontal supports 1200 support an undeterministic bot travel surface similar to the transfer deck 130B where the bot travel surface of the driveways 130BD extends from and forms a portion of the transfer deck 130B at a respective storage level 130L of the storage structure 130.

Referring again to FIG. 2A each transfer deck or storage level 130L includes one or more lift pickface interface/handoff stations TS (referred to herein as interface stations TS that may be located along a side of a transfer deck 130B, along a side of a driveway 130BD, and/or along a side of a picking aisle 130A) where case unit(s) (of single or combined case pickfaces) or totes are transferred between the lift load handling devices (also referred to herein lift robots) LHD and bots 110. In FIG. 2A the interface stations TS are illustrated as being located at a side of the transfer deck 130B opposite the picking aisles 130A and rack modules RM, so that the transfer deck 130B is interposed between the picking aisles and each interface station TS. FIG. 2A also illustrates an interface station along a side of a portion of a picking aisle 130A. As noted above, each bot 110 on each picking level 130L has access to each storage location 130S, each picking aisle 130A and each lift 150 on the respective storage level 130L, as such each bot 110 also has access to each interface station TS on the respective level 130L. In one aspect the interface stations are offset from high speed bot travel lanes or directions HSTP along the transfer deck 130B so that bot 110 access to the interface stations TS is undeterministic to bot speed on the high speed travel lanes or directions HSTP. As such, each bot 110 can move a case unit(s) (or pickface, e.g. one or more cases, built by the bot) from every interface station TS to every storage space 130S corresponding to the deck level and vice versa. FIG. 2B illustrates the interface stations TS as being located at a side of the driveways 130BD.

Referring now to FIGS. 3A, 3H, 3I, 5A, and 5B, as described above, the lifts 150 are integrated to and leverage the storage structure 130 so as to form mast-less lifts. For example, the load handling device LDH of the lift 150 is configured to travel in the vertical or Z direction along one or more rails or tracks 370A, 370B, where the one or more rails or tracks 370A, 370B are coupled to or otherwise integral with adjacent vertical support members 1212. For exemplary purposes only, the one or more rails or tracks 370A, 370B may be coupled directly to the storage structure 130 (such as to the vertical support members 1212) so that the lift 150 is a mastless lift (see also, e.g., FIGS. 3D, 3F, 3I, and 3J). The rails or tracks 370A, 370B of the lifts 150, and hence the lifts 150, may be disposed at any location within the storage structure 130 (e.g., along picking aisle 130A, along the transfer deck 130B, along a driveway 130BD or at any other suitable location where the bot 110 travels and places case units CU to a transfer station TS/buffer station BS for an indirect handoff to the lift 150 or to the load handling device LHD of the lift for a direct handoff to the lift 150). Here, the load handling device LHD is mastless, where a chassis or carriage 350 of the load handling device LHD is arranged to seat onto and engage a riding surface 371-373 of the storage rack structure 130 so as to define a lift axis LAX of the load handling device LHD mastlessly.

Coupling or integrating the one or more rails or tracks 370A, 370B with the vertical support members 1212 inherently and automatically substantially and inherently aligns the path of travel of the load handing device LHD, and a case support plane 399 (see FIG. 3A) of extension/retraction of the load handling device LHD with the storage structure and its components (e.g., components such as case unit support plane(s) TSSP of the transfer station(s) TS (FIG. 3A), case unit support plane of the bot 110, or any other case unit supporting feature which the load handling device may interface with for picking and placing case units CU), upon installation of the vertical support members 1212 in the storage structure 130, which may reduce lift installation and setup time (compared to conventional lifts with their own mast structure coupled to the storage structure) and reduce the cost of the lift (by reducing the number of lift components). For example, in constructing the storage structure 130 the vertical support members 1212 are set plumb (e.g., squared off of the level horizontal plane X-Y) relative to the horizontal plane X-Y. The horizontal support members 1200 (and the components supported thereby including the transfer decks 130B, rails 1200S, transfer stations TS, buffer stations BS, storage shelves, etc.) are set to lay in the horizontal plane X-Y. Here, with the load handling device riding along one or more rails or tracks 370A, 370B that extend along a length of the vertical support members, the path of travel in the Z direction and the case support plane 399 of the load handling device LHD is inherently aligned (e.g., in the Z direction and in the horizontal plane X-Y) with the storage structure components.

The cross section of each of the one or more rails or tracks 370A, 370B (and corresponding guide wheel configuration of the lift 150) may be any suitable cross section (and corresponding guide wheel configuration) that facilitates constraint of the load handling device in directions D1, D2, CM1, CM2, CM3 as illustrated in FIG. 3G. For example, referring to FIGS. 3A and 3H, each of the one or more rails or tracks 370A, 370B is configured such that each rail or track 370A, 370B forms two opposing (e.g., substantially parallel) guide surfaces 371, 372 and one (end) guide surface 373, where the end guide surface 373 is substantially orthogonal to the opposing guide surfaces 371, 372. In other aspects, as illustrated in FIG. 3I-3K, each rail or track 370A, 370B includes opposing angled guide surfaces 371A, 372A. The one or more rails or tracks 370A, 370B may be formed of any suitable material (including but not limited to aluminum and steel) and be formed in any suitable manner (including but not limited to extrusion, roll formed, and structural).

For exemplary purposes, referring to FIG. 3A, in some aspects each of the one or more rails 370A, 370B has a substantially L-shaped cross section including the guide surfaces 371-373 however, in other aspects (such as illustrated in FIG. 3H) each rail may have any suitable open cross section (e.g., such as a U shaped cross section). In other aspects, each of the one or more rails or tracks 370A, 370B may be a substantially flat plate or flange that includes the guide surfaces 371-373 and extends from a respective vertical support member 1212. In still other aspects, referring to FIGS. 31 and 3J, the one or more rails 370A, 370B have a customized cross section so that adjacent lifts 150 share a common (i.e., the same) rail or track 370A, 370B. The rails or tracks 370A, 370B are disposed on adjacent vertical support members 1212 so that the guide surfaces 371-372 or 371-373 of a respective lift 150 face or extend towards each other.

Each of the load handling devices or lift robots LHD has chassis or carriage 350. The carriage 350 defines a lift axis LAX of the load handling device LHD. As described herein, the carriage 350 has a frame 350F with a wheel set WST (e.g., any combination of guide rollers GR1-GR8 of the guides 341A-341D described herein) mounted thereon. Each wheel or guide roller GR1-GR8 of the wheel set WST contacts a riding or guide surface (e.g., a respective one or more of guide surfaces 371, 372, 373) of the storage rack structure 130 and supports the carriage 350 on the storage rack structure 130 so that load handling device LHD rides on the storage rack structure 130 throughout a complete range of motion of the load handling device LHD. The load handling device LHD includes a payload bay PLB connected to the carriage 350 where the payload bay PLB has a payload bed PLBD, for holding a payload (such as one or more case units CU) thereon. The payload bed PLBD (and case unit support plane 399 formed thereby) is disposed angled to the lift axis LAX. As described herein, the wheel set WST is configured so as to form a contact interface CINT arranged along a substantially upright plane VP including the lift axis LAX and the contact interface defines a lift interface engaging the riding surface (e.g., one or more of guide surfaces 371, 372, 373).

In one or more aspects, the contact interface CINT is maintained substantially continuously throughout the complete range of motion (e.g., between and adjacent a bottom and adjacent a top of the storage rack structure 130 so that all levels 130L are accessed) of the load handling device LHD. In one or more aspects, the lift interface defined by the contact interface CINT is a common contact interface between the load landing device LHD and storage rack structure 130 throughout the complete range of motion (e.g., between and adjacent a bottom and adjacent a top of the storage rack structure 130 so that all levels 130L are accessed) of the load handling device LHD. In one or more aspects, the lift interface (defined by the contact interface CINT) defines a fulcrum about which the end effector 360 in the extended position generates a moment on the carriage 350 opposing an overturning moment from of the payload bay PLB on the carriage 350 (see FIG. 3G).

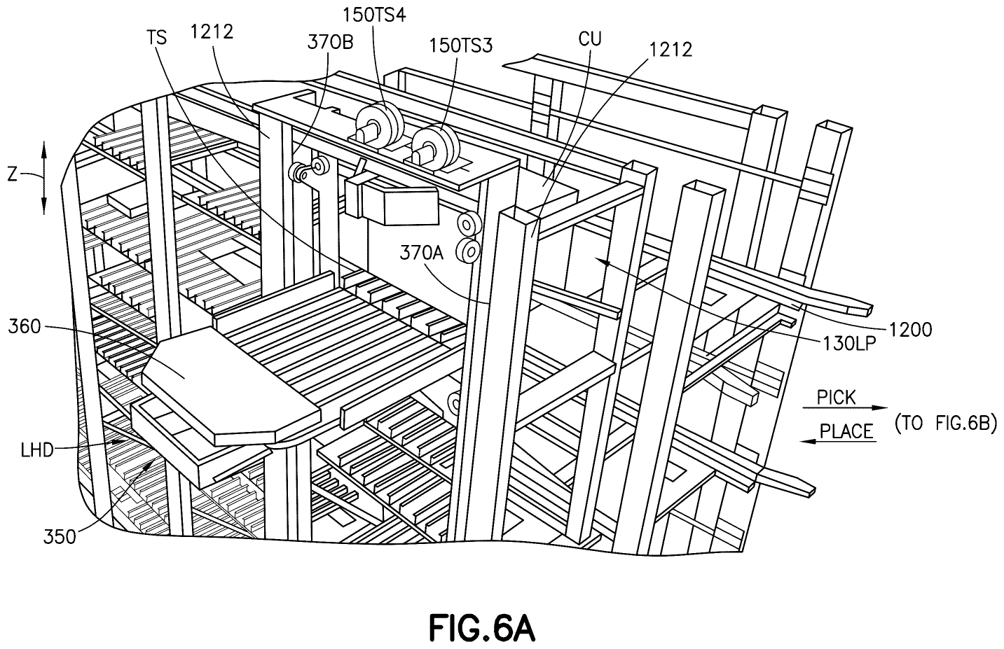

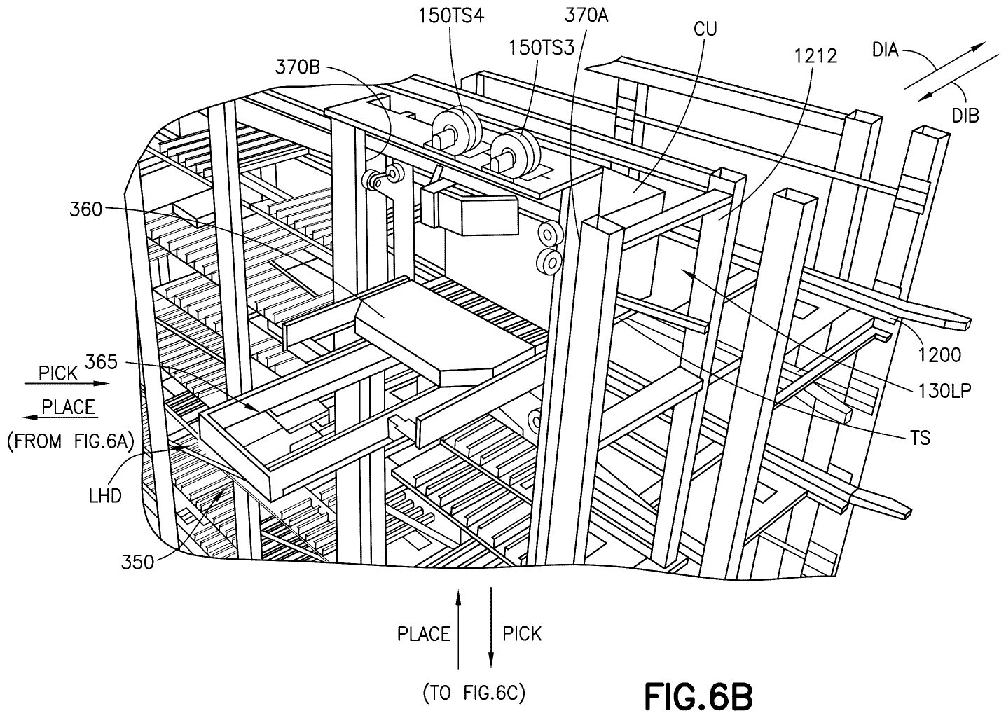

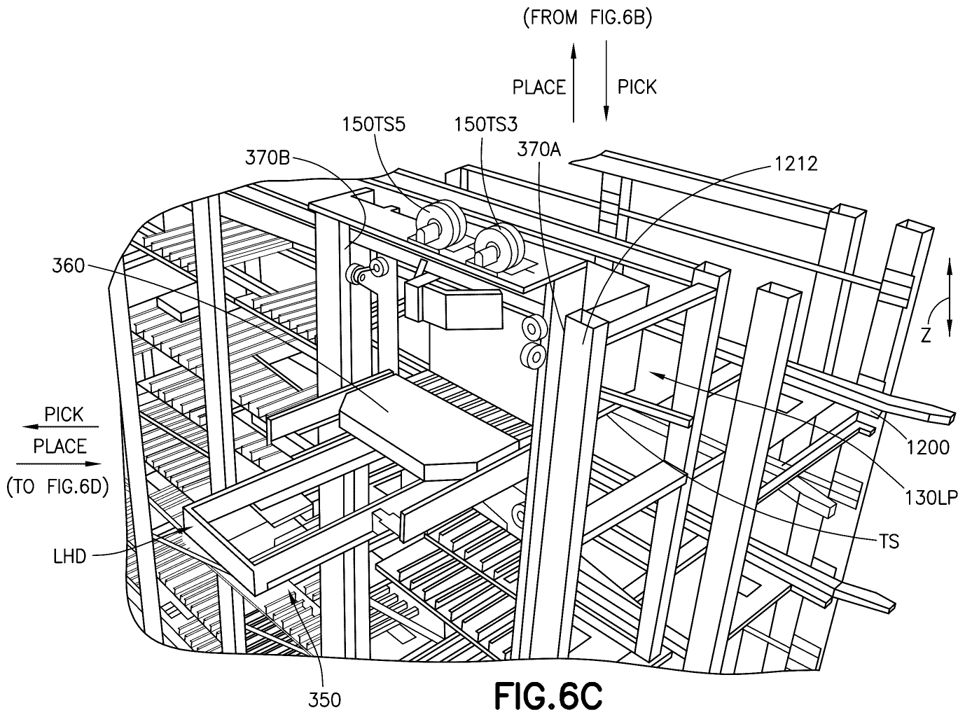

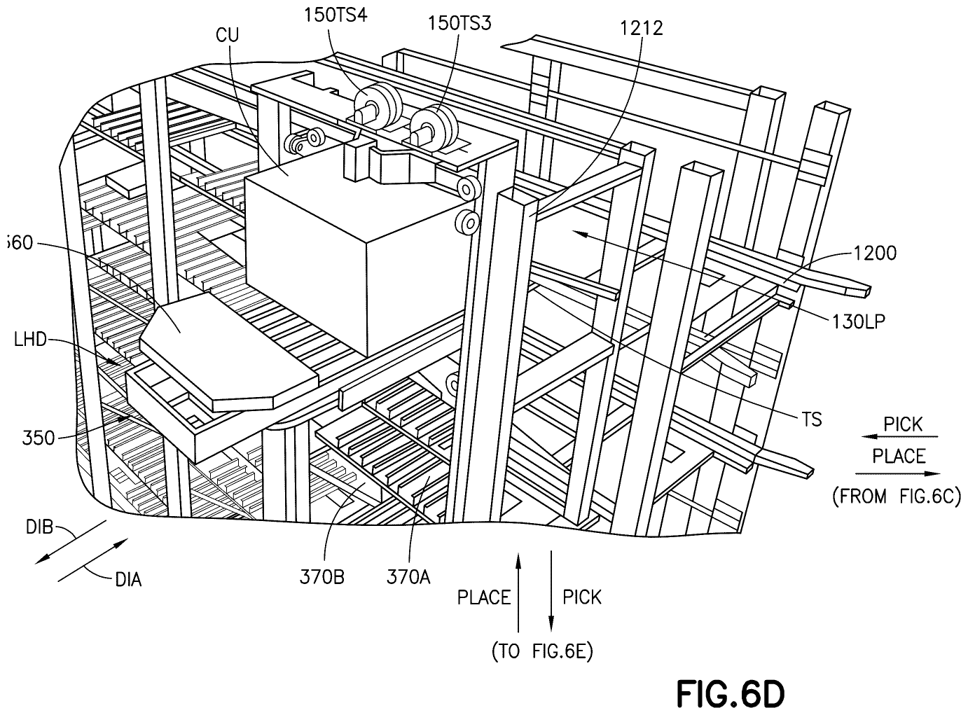

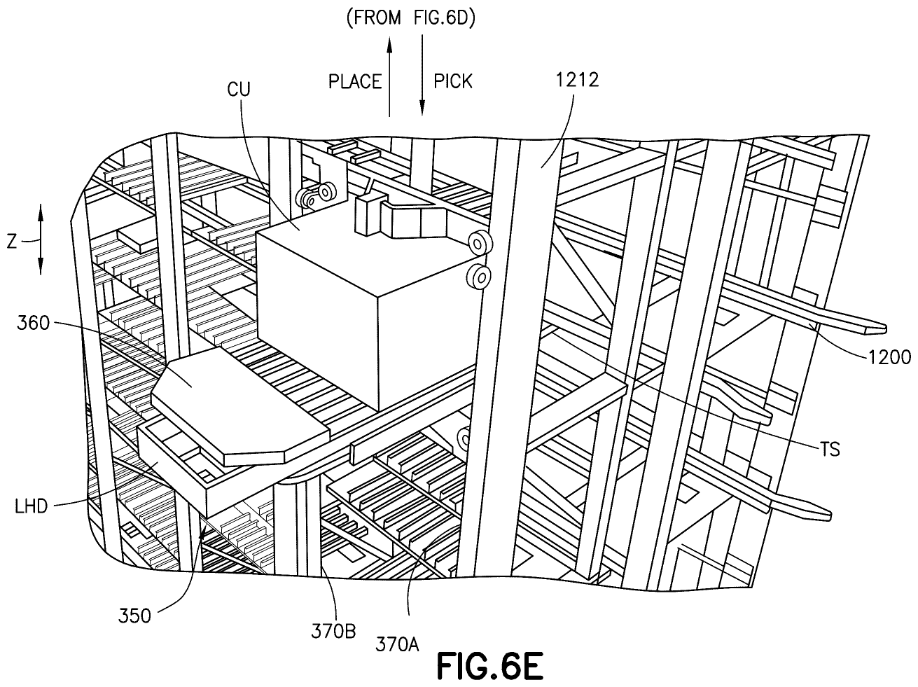

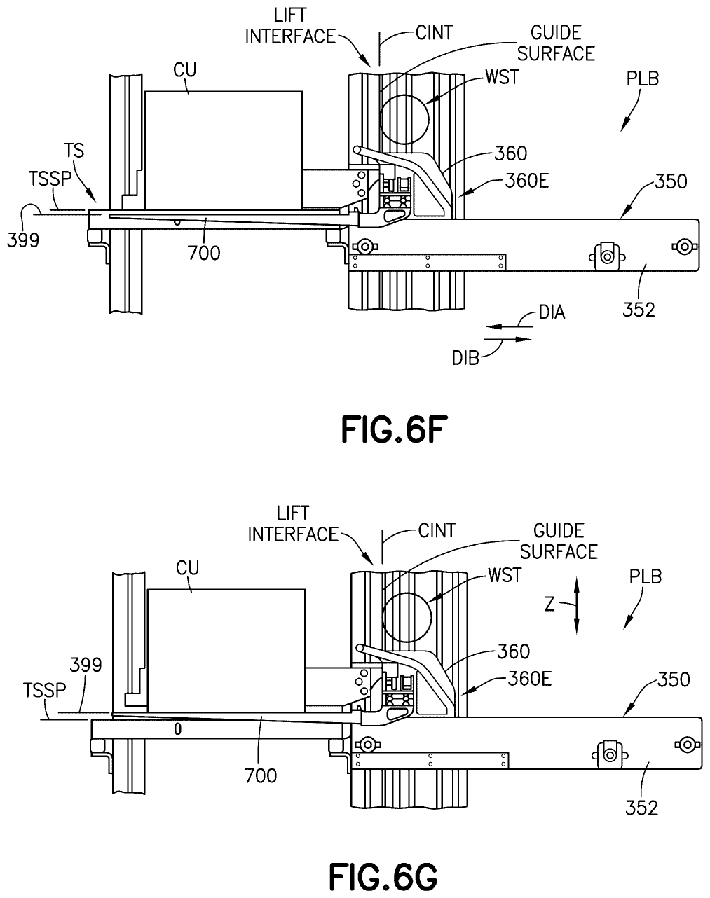

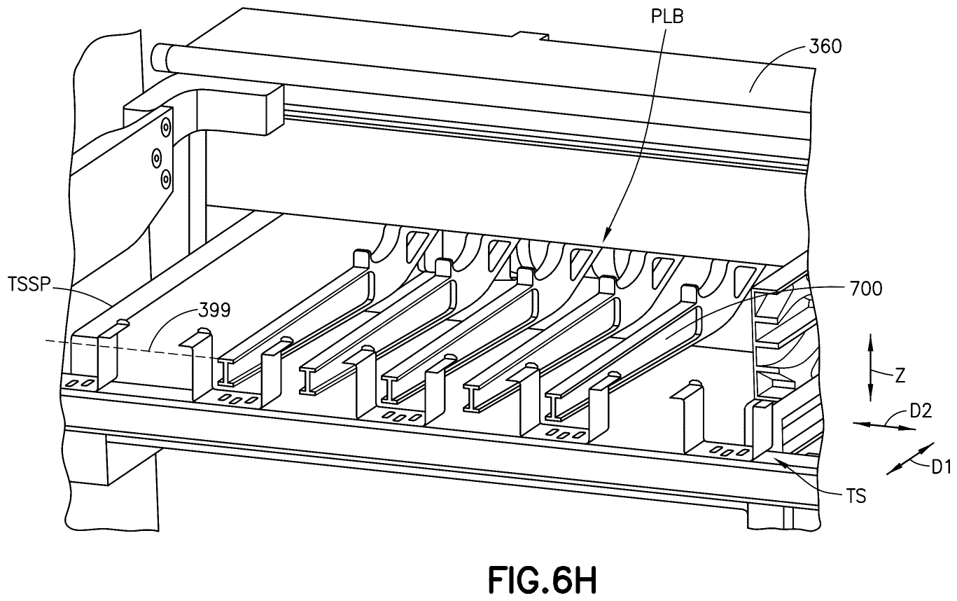

As illustrated in the figures (see, for example, FIGS. 3A, 3H, 3I, 6F, and 6G), the payload bay PLB is on one side of the contact interface CINT, and has a bay longitudinal axis BAX that extends aside and projects from a side of the contact interface CINT (see, e.g., FIGS. 3A, 3H, and 3J). In some aspects, the payload bay PLB projects aside from but one side of the contact interface CINT in a substantially cantilevered configuration (see FIGS. 3A and 3H). The end effector 360, in the extended position, and the payload bay PLB are on opposite sides of the lift interface and the end effector 360 in the extended position substantially balances the payload bay PLB. The end effector 360 in the extended position extends along an extension axis (e.g., in direction D1) from one side of the lift interface, where the lift interface is disposed adjacent an end 360E of the end effector 360 in the extended position.

As can be seen in, for example, at least FIGS. 3A, 3H, and 3I, and as described herein, the payload bed PLBD is substantially orthogonal to the contact interface CINT and the lift axis LAX. The payload bed PLB is disposed angled to the lift axis LAX. The payload bay PLB cantilevers from the carriage 350.

In one aspect, as illustrated in FIG. 3A, the carriage 350 has a substantially upright frame 350F with a longitudinal axis FAX that is substantially aligned with the lift axis LAX. Here, the substantially upright frame 350F includes a boxed section 351 and an end effector support section 352 (e.g., that in some aspects forms at least one side of the boxed section 351, while in other aspects is disposed between longitudinal (e.g., in the Z direction) sides of the boxed section 351) that are arranged relative to each other so that an end effector or transfer arm 360 movably coupled to the end effector support section 352 extends through an aperture 351A formed by the boxed section 351. In other aspects, as described herein the substantially upright frame 350F includes a U-shaped section 351U. The boxed section 351 extends in the Z direction for movably coupling the load handling device LHD to the one or more rails or tracks 370A, 370B. For example, referring also to FIGS. 3C-3F the boxed section 351 includes guides 341A-341D that interface or otherwise engage the guide surfaces 371-373. Each of the guides 341A-341D includes opposing guide members that maintain a position of the carriage 350 relative to rails or tracks 370A, 370B in a first direction D1 that is substantially orthogonal to the Z direction. Each of the guides 341A-341D also includes lateral guide members that maintain a position of the carriage 350 relative to the rails or tracks 370A, 370B in a second direction D2 that is substantially orthogonal to the first direction D1 and the Z direction.

As can be seen in FIGS. 3C and 3D, the guide 341A includes guide roller GR1 disposed on one side of the rail or track 370A so as to engage guide surface 371. The guide 341A also includes guide rollers GR2, GR3 disposed on the opposite side of the rail or track 370A (so as to oppose the guide roller GR1) so as to engage the guide surface 372. The guide 341A includes lateral guide roller GR4 that engages the end guide surface 373 of the rail or track 370A. To accommodate any irregularities (e.g., bends, protrusions, recesses, etc.) in the rail or track 370A, the guide rollers GR2, GR3 are mounted/coupled to a walking beam WB that is coupled to the carriage 350 for rotation about pivot axis PX1. Here, the guide rollers GR2, GR3 are coupled to the walking beam WB, at opposite ends of the walking beam WB so as to be disposed on opposite sides of the pivot axis PX1. The guide roller GR1 is coupled to the carriage 350 so that an axis of rotation GR1X of the guide roller GR1 is substantially in-line with the pivot axis PX1 so that an imaginary line extending between the pivot axes PX1, GR1X is substantially orthogonal to the rail or track 370A. In this manner, the guide rollers GR2, GR3 are free to pivot, with the walking beam WB, about pivot axis PX1 as the guide 341A moves along the rail or track 370A so as to accommodate any irregularities in the rail and prevent binding of the opposing guide rollers GR1-GR3 with the rail or track 370A. In some aspects, there may be one or more biasing members BM (e.g., coil springs, torsion springs, leaf springs, etc.) disposed between the walking beam WB and the carriage 350 so as assist in maintaining contact of the guide rollers GR2, GR3 with the guide surface 372.

It should be understood that the guide 341B is substantially similar to guide 341A, but opposite in hand so that the guide rollers GR4 engage the end guide surface 373 of the respective rails or tracks 370A, 370B in an opposing manner so as to laterally constrain the carriage in direction D2 between the rails or tracks 370A, 370B.

As can be seen in FIGS. 3E and 3F, the guide 341C includes guide roller GR5 disposed on one side of the rail or track 370B so as to engage guide surface 372. The guide 341A also includes guide rollers GR6, GR7 disposed on the opposite side of the rail or track 370B (so as to oppose the guide roller GR5) so as to engage the guide surface 371. The guide 341C includes lateral guide roller GR8 that engages the end guide surface 373 of the rail or track 370B. To accommodate any irregularities (e.g., bends, protrusions, recesses, etc.) in the rail or track 370B, the guide rollers GR6, GR7 are mounted/coupled to a walking beam WB that is coupled to the carriage 350 for rotation about pivot axis PX2. Here, the guide rollers GR6, GR7 are coupled to the walking beam WB, at opposite ends of the walking beam WB so as to be disposed on opposite sides of the pivot axis PX2. The guide roller GR5 is coupled to the carriage 350 so that an axis of rotation GR5X of the guide roller GR5 is substantially in-line with the pivot axis PX2 so that an imaginary line extending between the pivot axes PX2, GR5X is substantially orthogonal to the rail or track 370B. In this manner, the guide rollers GR6, GR7 are free to pivot, with the walking beam WB, about pivot axis PX2 as the guide 341C moves along the rail or track 370B so as to accommodate any irregularities in the rail and prevent binding of the opposing guide rollers GR5-GR7 with the rail or track 370B. In some aspects, there may be one or more biasing members BM (e.g., coil springs, torsion springs, leaf springs, etc.) disposed between the walking beam WB and the carriage 350 so as assist in maintaining contact of the guide rollers GR6, GR7 with the guide surface 371.

It should be understood that the guide 341D is substantially similar to guide 341C, but opposite in hand so that the guide rollers GR8 engage the end guide surface 373 of the respective rails or tracks 370A, 370B in an opposing manner so as to laterally constrain the carriage in direction D2 between the rails or tracks 370A, 370B.

It is noted that walking beam WB guide rollers GR4, GR5 and the walking beam WB guide rollers GR6, GR7 on a common lateral side of the carriage 350 are disposed on an opposite sides of a common rail or track 370A, 370B. For example, the guide rollers GR2, GR3 of guide 341A engage guide surface 372 of rail or track 370A while the guide rollers GR6, GR7 of guide 341D engage guide surface 371 of rail or track 370A. Similarly, the guide rollers GR2, GR3 of guide 341B engage guide surface 372 of rail or track 370B while the guide rollers GR6, GR7 of guide 341C engage guide surface 371 of rail or track 370B. Having the walking beam WB guide rollers GR2, GR3, GR6, GR7 disposed on opposite sides of the rails or tracks 370A, 370B in this manner may provide a self-leveling effect for the carriage 350 (and load handling device LHD as a whole with respect to the case support plane 399 (see FIG. 3A)), by allowing the walking beams WB to pivot about the respective axes PX1, PX2 while at the same time accommodating irregularities in the rails or tracks 370A, 370B.

Referring to FIG. 3H another exemplary carriage 350 of the load handling device LHD is illustrated. Here, the carriage 350 includes a U-shaped section 351U and an end effector support section 352 (e.g., that in some aspects forms at least one side of the U-shaped section 351U, while in other aspects is disposed between longitudinal (e.g., in the Z direction) sides of the U-shaped section 351U) that are arranged relative to each other so that the end effector or transfer arm 360 movably coupled to the end effector support section 352 extends between the longitudinal sides of the U-shaped section 351U. It should be understood that in this aspect, the U-shaped section 351U may be replaced with the boxed section 351 described above and vice versa. The U-shaped section 351U extends in the Z direction for movably coupling the load handling device LHD to the one or more rails or tracks 370A, 370B. For example, the U-shaped section 351U includes guides 341A-341D that are substantially similar to those described above with respect to FIGS. 3A and 3C-3F, except where noted. Here, the guides 341A-341D interface or otherwise engage the guide surfaces 371-373 in a manner substantially similar to that described above. Each of the guides 341A-341D includes a walking beam guide member arrangement (substantially similar to that described above) that includes the walking beam WB and guide members GR2, GR3 that are coupled to the U-shaped section 351U in a manner substantially similar to that described above with respect to FIGS. 3A and 3C-3F. The guide members FR2, GR3 engage the guide surfaces 371, 372 of the respective rail or track 370A, 370B so as to maintain a position of the carriage 350 relative to rails or tracks 370A, 370B in the first direction D1 that is substantially orthogonal to the Z direction. Here, because the each rail or track 370A, 370B has a C-shape, the opposing guide members GR1, GR5 may be omitted.

In this aspect, the outer (relative to the carriage 350) sides of the guide members GR2, GR3 may engage the surface 373 so as to maintain a position of the carriage 350 relative to the rails or tracks 370A, 370B in the second direction D2 that is substantially orthogonal to the first direction D1 and the Z direction. In other aspects, the each of the guides 341A-341D may include lateral guide members, substantially similar to guide members GR4, GR8 described above for engaging the surface 373.

Referring to FIGS. 3I-3K, yet another exemplary carriage 350 of the load handling device LHD is illustrated. Here, the carriage 350 includes the U-shaped section 351U and an end effector support section 352 (e.g., that in some aspects forms at least one side of the U-shaped section 351U, while in other aspects is disposed between longitudinal (e.g., in the Z direction) sides of the U-shaped section 351U) that are arranged relative to each other so that the end effector or transfer arm 360 movably coupled to the end effector support section 352 extends between the longitudinal sides of the U-shaped section 351U. It should be understood that in this aspect, the U-shaped section 351U may be replaced with the boxed section 351 described above and vice versa. As noted above, the U-shaped section 351U extends in the Z direction for movably coupling the load handling device LHD to the one or more rails or tracks 370A, 370B. For example, the U-shaped section 351U includes guides 341A-341D. In this aspect, each guide 341A-341D includes at least one pair of opposing guide members GR1, GR2 where the axes of rotation of the opposing guide members GR1, GR2 are angled relative to each other by, for example about 90° (see FIG. 3K—although in other aspects the angle may be greater or less than about) 90° so as to react forces exerted on or by the carriage 350 in both directions D1, D2. The guide members GR1, GR2 of each guide 341A-341D may be coupled to the carriage 350 by a walking beam WB in a manner substantially similar to that described above. Here, the rails or tracks 370A, 370B include corresponding guide surfaces 371A, 372A that are angled relative to each other by an amount substantially equal to the angle between the guide member GR1, GR2 axes of rotation so that the guide members GR1, GR2 engage the respective guide surface 371A, 372A for constraining movement of the load handling device in directions D1, D2.

It should be understood that while different examples of load handling devices LHD were described above, in other aspects the features of the different load handling devices may be combined in any suitable manner so long as the load handling device travels along the rails or tracks 370A, 370B in the Z direction and is constrained in directions D1, D2, CM1, CM2, CM3 as illustrated in FIG. 3G.

In some aspects, the carriage 350 of the load handling device LHD may include one or more braces 377 that extend between the U-shaped section 351U and the end effector support section 352 or between the boxed section 351 and the end effector support section 352. For example, with reference to FIG. 3H noting that the load handling devices LHD of FIGS. 3A and 3I may include a similar brace, one or more braces 377 that extend between the boxed or U-shaped section 351, 351U and the end effector support section 352 so as to support any cantilevered load on the end effector support section 352. The braces 377 may be any suitable braces including, but not limited to, turnbuckles, wires, rods, bars, tubes and any combination thereof. In other aspects, the stiffness of the carriage 350 may be sufficient so that the braces 377 may be omitted.

The guides 341A-341D are mounted to the carriage 350 (such as to, for example, the boxed section 351 or the U-shaped section 351U) in respective predetermined locations relative the case support plane 399. For example, the case support plane 399 forms a datum from which the guides 341A-341D are located on the carriage 350. Here, the guides 341A-341D are positioned on the carriage 350 relative to each other and the case support plane 399 so that with the carriage 350 mated (or otherwise coupled) to the rails or tracks 370A, 370B the lift axis LAX of the load handing device LHD is defined so that the case support plane 399 is automatically or inherently aligned/leveled (i.e., substantially parallel or coplanar, by virtue of the rails or tracks 370A, 370B being coupled to or integral with the storage structure 130B and the predetermined location of the guides on the carriage) with respect to the case unit support surfaces of the transfer stations TS, buffer stations BS, the bot travel surfaces (and hence the case unit support surface of the bot 110), and any other surface from which the load handling device LHD of the lift 150 may pick or place one or more case units CU.

It should be understood the configuration of the guides 341A-341D are exemplary, and in other aspects the guides may have any other suitable configuration that provides for leveling of the case support plane 399 (substantially coincident with coupling of the carriage 350 to the rails or tracks 370A, 370B) and travel of the load handling device LHD along the rails or tracks 370A, 370B as described herein. It should also be understood while the guides 341A-341D are described as having guide rollers, in other aspects the rollers may be slides or any other member that is configured to engage a surface and move along that surface.

In the load handling devices LHD described herein, the payload bay PLB cantilevers from the carriage 350. The payload bay PLB is arranged so that the payload bed PLBD cantilevers substantially orthogonal from the carriage 350.

For illustrating the constraint on the carriage 350 (and the load handling device LHD as a whole) effected by the guides 341A-341D and rails or tracks 370A, 370B, a force diagram is provided in FIG. 3G. As can be seen in the figure, any moment CM1-CM3 about the directions Z, D1, D2 (which may be considered fulcrums of the lift interface defined by the contact interface CINT of the wheel set WST, e.g., with one or more of the surface 371-373) or force exerted in the directions D1, D2 is counteracted by the guides 341A-341D to maintain the path of travel of the load handling device in direction Z and to maintain a pose of the load handling device (and the case support plane 399 (see FIG. 3A) of extension/retraction of the load handling device LHD) substantially orthogonal to the direction Z and substantially parallel with any load handling transfer surface to and from which the load handling device may pick or place case units (e.g., an end effector case support surface of a bot 110, a transfer station, TS, buffer station BS, etc. with which the load handling device may interface for case unit CU transfer).

As illustrated in, for example, FIGS. 3A, 3H, and 3I, the guides 341A-341D are disposed on the carriage 350 so that the one or more rails or tracks 370A, 370B are located adjacent to what may be referred to for explanatory purposes only as the front (e.g., a side of from which the end effector 380 extends) of the load handling device LHD. This arrangement of the load handling device that locates the one or more rails or tracks 370A, 370B adjacent the front of the load handling device LHD may reduce any cantilevered loads that are applied to the load handling device LHD and the one or more rails or tracks 370A, 370 with the end effector 360 extended in direction D1 for picking and placing one or more case units CU. For comparison, conventional mast lifts generally have the guide tracks located behind the load handling device away from the storage structure which configures the conventional load handling device with a very long cantilever with the end effector extended, which in turn generates higher forces on the conventional load handling device and guide tracks. The configuration of the load handling device LHD and the one or more rails or tracks 370A, 370 of the present disclosure reduce the length of cantilever of the load handling device (compared to the conventional load handling device) by more than about half and reduces the forces exerted on the load handling device LHD and one or more rails or tracks 370A, 370B. Here, the load handling device LHD and guides 341A-341D thereof and one or more rails 370A, 370B may be of a lighter weight than their conventional counterparts due to the reduced loading exerted on the load handling device LHD of the present disclosure.

Referring to FIGS. 3A and 3B, the end effector support section 351 includes one or more guide rails 366A, 366B that extend in the direction D1 and along which the end effector travels 260 between a retracted position (e.g., shown in FIGS. 3A and 6) and an extended position (e.g., shown in FIG. 6). Two guide rails 366A, 366B are illustrated for exemplary purposes; however, in other aspects, there may be more or less than two guide rails on and along which the end effector 360 travels. An end effector drive 365 is coupled to the end effector support section 351 and travels with the end effector support section 351 in the Z direction as the load handling device LHD is raised and lowered along the rails or tracks 370A, 370B. The end effector drive 365 includes any suitable motor 365M and any suitable transmission 365T configured to effect extension and retraction of the end effector 360 in direction D1 along the one or more guide rails 366A, 366B. For exemplary purposes only, the motor 365M may be any suitable electric motor (e.g., stepper motor, brushless motor, induction motor, AC motor, DC motor, etc.) and the transmission 365T may be a belt/pulley transmission, a chain/sprocket transmission, a ball screw transmission, or any other suitable transmission. In other aspects, the end effector drive 365 may be a pneumatic cylinder drive, a hydraulic cylinder drive, an electric linear actuator, or any other suitable linear actuator. Electric power and/or actuating fluid may be provided to the end effector drive 365 and other components of the load handling device (e.g., such as sensors, etc.) via passage of electrical cables and/or pneumatic hoses though a drag chain cable carrier 333 or any other suitable flexible conduit. A fixed end 333F of the drag chain cable carrier 333 may be coupled to a vertical support member 1212 of a respective lift 150 at a height HH substantially equal to about half of the total vertical travel TVT of the load handling device LHD (see FIG. 5A) so that an amount of cabling/hoses for lift 150 operation is minimized. In other aspects, sliding power/communication connectors may be provided in lieu of the drag chain cable carrier 333, where the power/communication rail extends along one or more vertical support member 1212 (e.g., in a manner similar to rails or tracks 370A, 370B) and the sliding power/communication connector is coupled to the carriage 350.

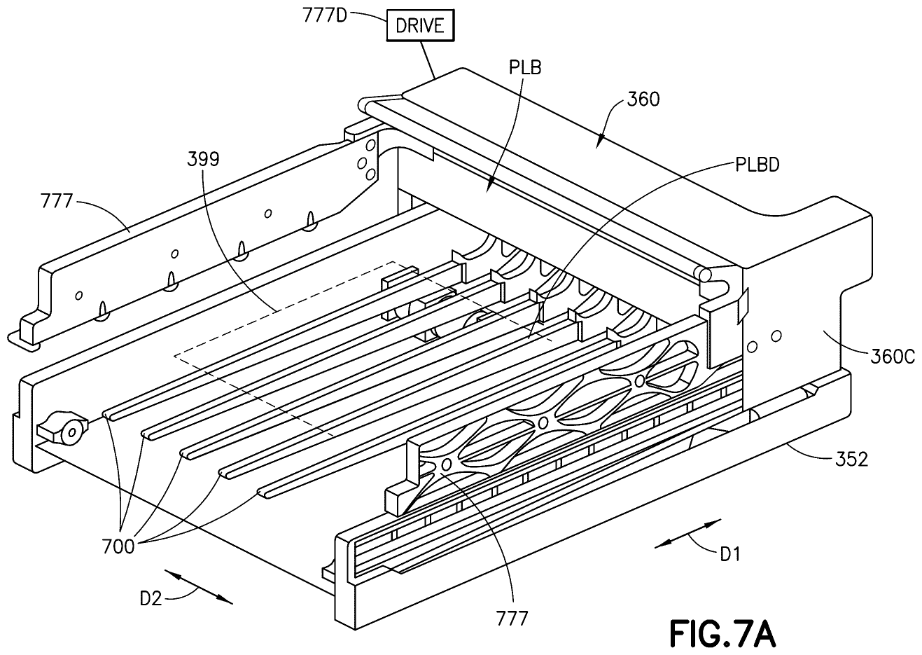

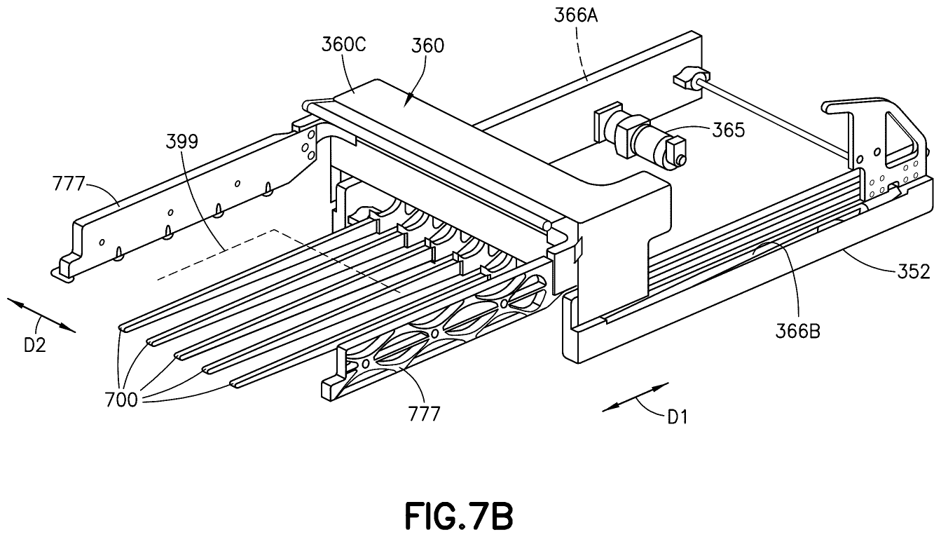

Referring to FIGS. 3A, 3B, 7A, and 7B, the end effector 360 will be described. The end effector 360 is an actuated end effector that is included in a payload bay PLB of the load handling device LHD. The end effector 360 is disposed so as to extend and retract with respect to the chassis 350 along an extension axis (e.g., in direction D1) to transfer payload (such as one or more case units CU) to and from the load handling device LHD, where the extension axis crosses the lift axis LAX.

The end effector 360 includes a carriage 360C from which one or more tines 700 extend in a cantilevered manner. The tines 700 are spaced apart from one another so that, with extension of the end effector in direction D1, the tines 700 are interdigitated with case unit supports of, for example, the transfer or buffer stations TS, BS (see FIGS. 6A-6H). The tines 700 are configured (e.g., shaped and sized) so as to be extended underneath (i.e., underpick) one or more case unit CU held at, e.g., the transfer or buffer station TS, BS and support the one or more case unit CU on the tines 700 with transfer of the one or more case unit from the transfer or buffer station TS, BS to the tines 700 in the manner described herein. In some aspects, as illustrated in FIGS. 7A and 7B, the end effector may include side clamping members 777 that move in direction D2 under impetus of any suitable drive 777D so as to grip and release the one or more case unit CU held on the end effector 360. In other aspects, the end effector 360 may be provided with any suitable clamping members that engage one or more of the top of the one or more case units CU held on the end effector 360 or any one, or more of the vertical sides of the one or more case units CU held on the end effector.

Referring also to FIGS. 3A, 4A-4C, 4D, 4E, 5A, and 5B the lift 150 includes a lift drive 150D configured to move the load handling device LHD in the Z direction along the rails or tracks 370A, 370B. For exemplary purposes, the lift drive 150D includes a lift motor 150M and a transmission 150T (e.g., including, but not limited to, a chain and sprocket transmission a belt and pulley transmission, and a cable and pulley transmission). The lift motor 150M may be any suitable motor including but not limited to, e.g., stepper motor, brushless motor, induction motor, AC motor, DC motor, etc. The transmission 150T may include one or more transmission members 150TC as described herein. In other aspects any suitable drive configured to effect linear traverse (i.e., movement) of the load handling device LHD vertically along the rails or tracks 370A, 370B may be employed (e.g., such as pneumatic linear actuators, hydraulic linear actuators, electric linear actuators, etc.).

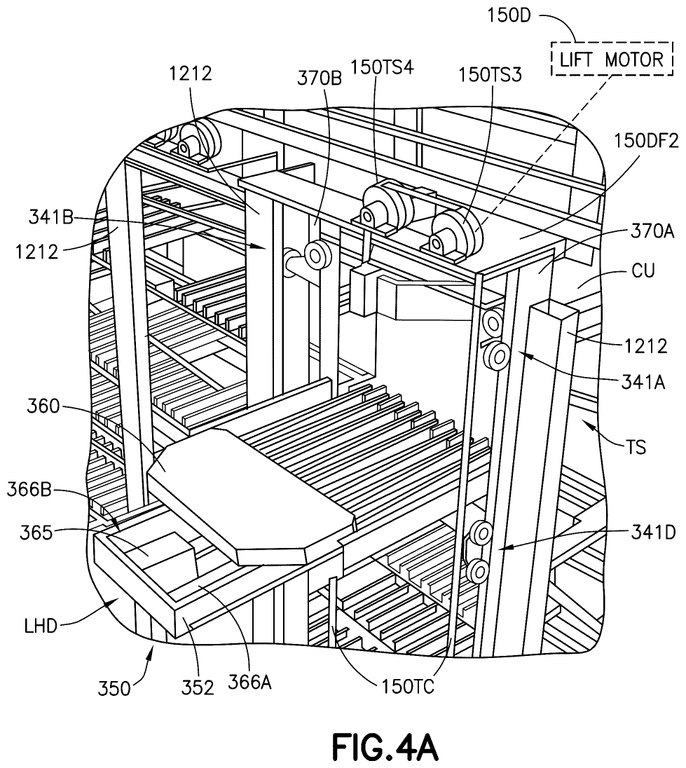

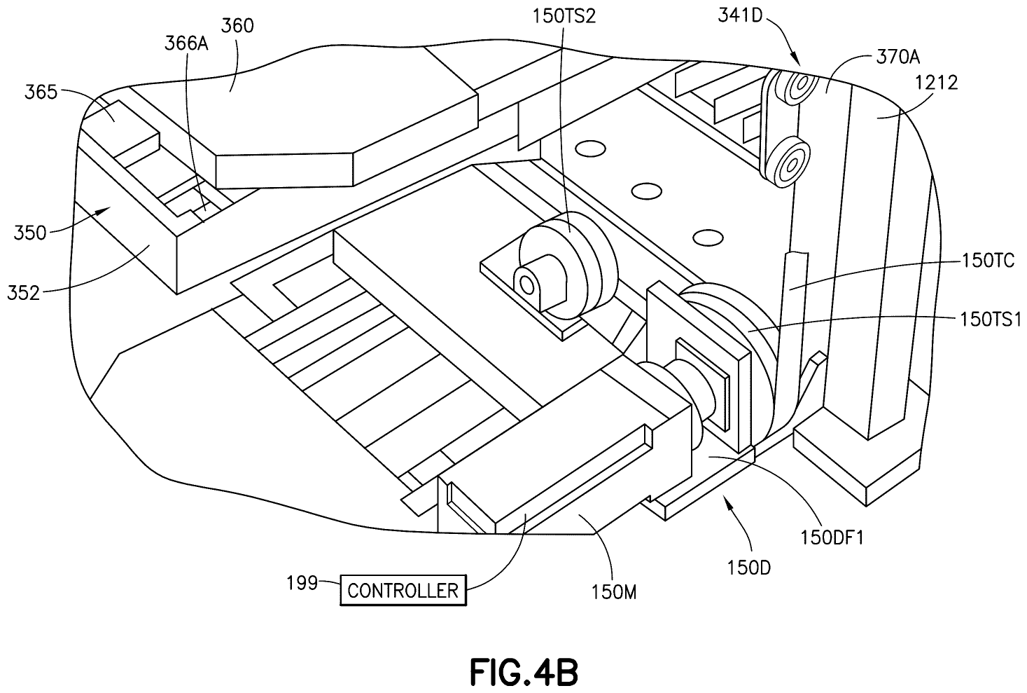

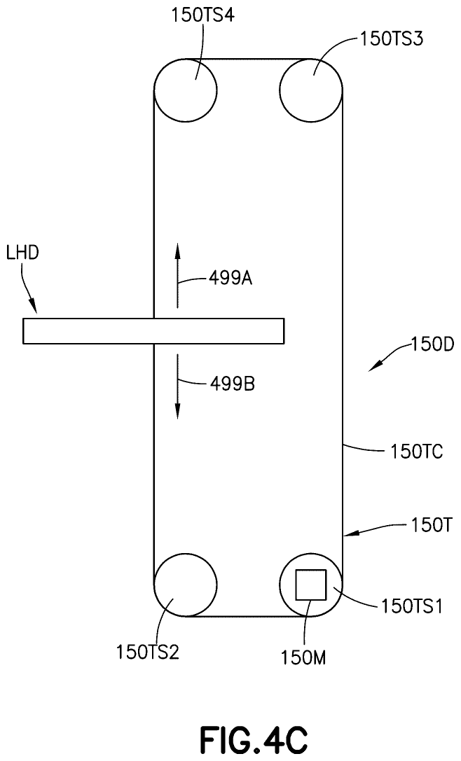

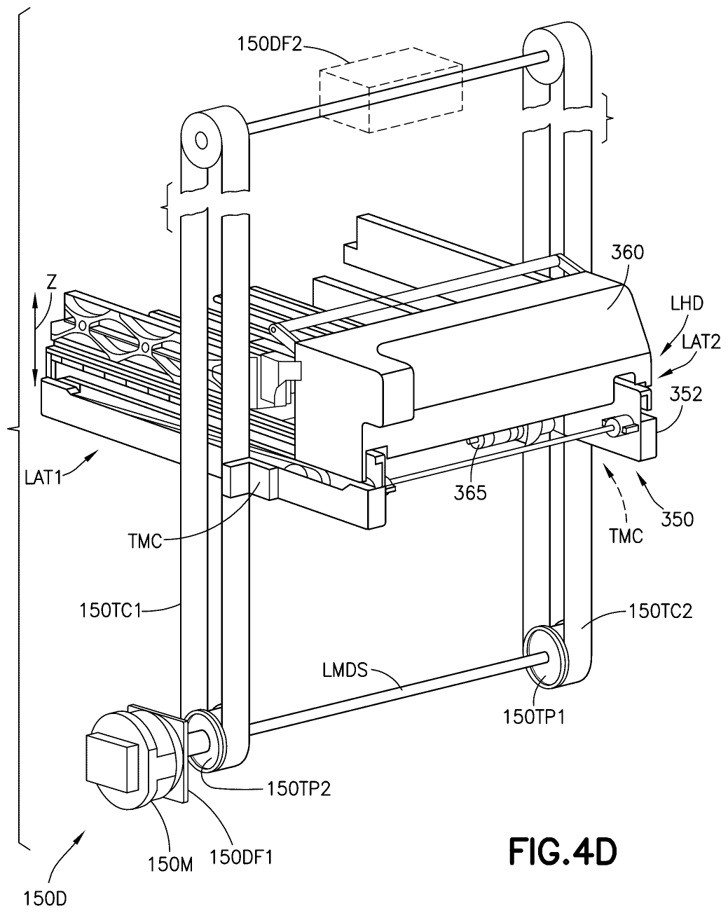

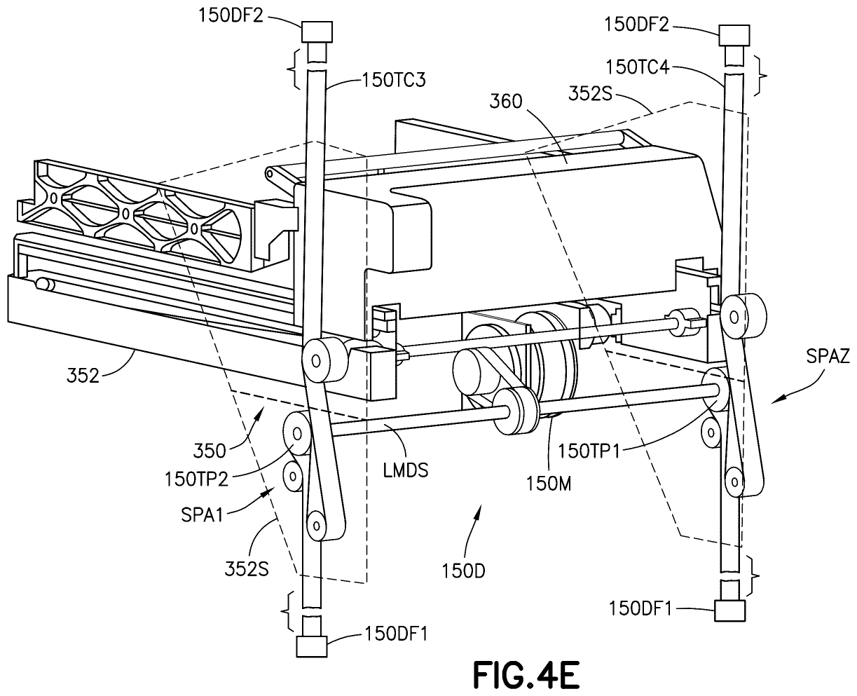

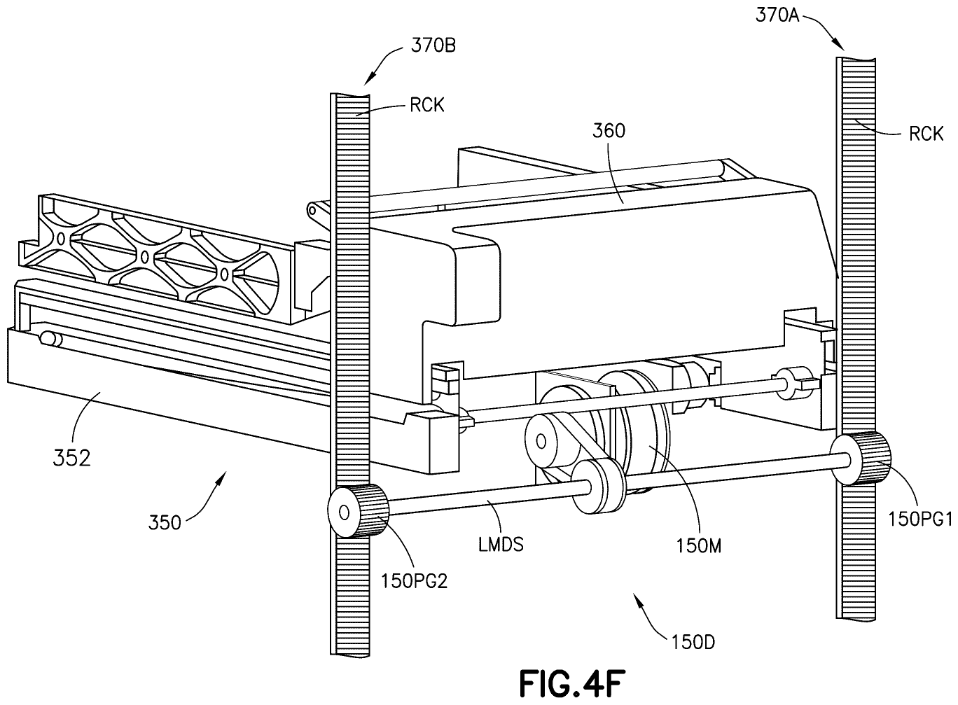

The drive 150D illustrated in FIGS. 3A, 4A-4C, 5A, and 5B is configured as what may be referred to as a circulating drive where the transmission member 150TC is circulated by the drive 150D. Here, one end of the chain, belt, or cable (collectively referred to herein as a transmission member 150TC) is coupled to a top portion of the load handling device LHD in any suitable manner (such as to a top portion of the boxed section 351) and another (opposite) end of the transmission member 150TC is coupled to a bottom portion of the load handling device LHD in any suitable manner (such as to a bottom portion of the boxed section 351 or end effector support section 352). The transmission member 150TC engages a set of sprockets 150TS1-150TS4 arranged for directing circulation of the transmission member 150TC along a substantially loop shape path where the load handling device LHD is raised and lowered in directions 499A, 499B along one leg or side of the loop (see FIG. 4C). At least one of the sprockets 150TS1-150TS4 is coupled to and driven by the lift motor 150M so as to circulate the transmission member 150TC and raise or lower the load handling device LHD in directions 499A, 499B. Here, for exemplary purposes, the lift motor 150M is coupled to the storage structure 130 adjacent the facility floor so as to drive sprocket 150TS1 (see FIG. 4B—although in other aspects sprocket 150TS2 may be driven with the lift motor 150M adjacent the floor, or the lift motor 150M may be disposed at a top of the storage structure for driving one or more of sprockets 150TS3, 150TS4). In the example illustrated, sprocket 150TS1 may be referred to as a drive sprocket while sprockets 150TS2-150TS4 may be referred to as driven or idler sprockets.

The lift motor 150M and sprockets 150TS1, 150TS2 may be coupled to a drive mount 150DF1 (see FIG. 4B) that is coupled to the base or bottom of one or more of the vertical support members 1212 (such as the same adjacent vertical support members to which the rails or tracks 370A, 370B of a respective lift 150 are coupled). The sprockets 150TS3, 150TS4 are coupled to a sprocket or pulley mount 150DF2 (see FIG. 4A) that is coupled to or adjacent the top of one or more of the vertical support members 1212 (such as the same adjacent vertical support members to which the rails or tracks 370A, 370B of a respective lift 150 are coupled).

FIG. 4D illustrates another example of a circulating drive that includes two transmissions members 150TC1, 150TC2 (although in other aspects there may be more or less than two transmission members) that are circulated, under impetus of the lift motor 150M, between a respective drive pulley 150TP1, 150TP2 disposed adjacent the drive mount 150DF1 (i.e., at a bottom of the storage structure 130 in a manner similar to that illustrated in FIG. 4B) and a respective idler pulley 150TP3, 150TP4 adjacent the pulley mount 150DF2 (i.e., at a top of the storage structure 130 in a manner similar to that illustrated in FIG. 4A). In this example, one side of a respective transmission loop formed by each of the transmission members 150TC1, 150TC2 is coupled to the carriage 350 (e.g., to one or more of the end effector support section 352 and the boxed or U-shaped section 351, 351U) in any suitable manner (such as by any suitable coupling TMC that includes clamps, bolts, etc.) so that the carriage 350 (and hence the load handling device LHD) moves in the Z direction with the transmission members 150TC1, 150TC2 as the transmission members 150TC1, 150TC2 are circulated. As described above, the lift motor 150M is coupled to the drive mount 150DF1 for driving the pulleys 150TP1, 150TP2 (e.g., through a common or same drive shaft LMDS) so that the lateral sides LAT1, LAT2 of the load handling device LHD are raised and lowered in the Z direction substantially simultaneously at the same rate upon actuation of the lift motor 150M. In other aspects, the lift motor 150M may be disposed at the top of the storage structure 130 in a manner similar to that described above with respect to FIG. 4A.

FIG. 4E illustrates an example of a non-circulating drive that includes two stationary transmission members 150TC3, 150TC4. In this aspect, one end (e.g., what may be referred to as a top end) of each transmission member 150TC3, 150TC4 is coupled to the top of the storage structure 130 (such as to a mount substantially similar to the pulley mount 150DF2). The other or opposite end of each transmission member 150TC3, 150TC4 is coupled to a bottom of the storage structure 130 (such as to a mount substantially similar to the drive mount 150DF1). Here, the lift motor 150M is coupled to the carriage 350 so as to travel as a unit with the carriage 350 in the Z direction. In this aspect, the carriage 350 has mounted thereto, for each transmission member 150TC3, 150TC4, a serpentine pulley arrangement SPA1, SPA2. For example, serpentine pulley arrangement SPA1 is coupled to a lateral side LAT1 of the carriage 350 for engaging the transmission member 150TC3, while the serpentine pulley arrangement SPA2 is coupled to the other lateral side LAT2 or engaging the other transmission member 150TC4. Each serpentine pulley arrangement SPA1, SPA2 includes a respective drive pulley 150TP1, 150TP2, each of which is coupled to the lift motor 150M by a common (i.e., the same) drive shaft LMDS. Here, as the lift motor 150M is actuated, the drive pulleys 150TP1, 150TP2 engage the respective transmission member 150TC3, 150TC4 (which are held against and wrapped around the respective pulleys 150TP1, 150TP2 by the serpentine path the transmission member 150TC3, 150TC4 through the respective serpentine pulley arrangement SPA1, SPA2) so that rotation of the drive pulleys 150TP1, 150TP2 effects movement (e.g., a climbing movement or a descending movement) of the load handling device LHD along the transmission members 150TC3, 150TC4. It is noted that mounting the lift motor 150M to the carriage 350 may provide increased floor space and simplified changing/replacement of the load handling device LHD compared to mounting the lift motor 150M to the drive mount 150DF1.

Referring to FIG. 4F, in another example, similar to that illustrated in FIG. 4E, the drive pulleys 150TP1, 150TP2 may be replaced with pinion gears 150PG1, 150PG2 that are driven in rotation by the lift motor 150M coupled to and carried by the carriage 350. In this aspect, each of the rails or tracks 370A, 370B (which engage the guides 341A-341D) includes a respective gear rack RCK that engages a respective pinion gear 150PG1, 150PG2. Here, rotation of the pinion gears 150PG1, 150PG2 by the lift motor 150M effects movement (e.g., a climbing movement or a descending movement) of the load handling device LHD along the gear racks RCK.

Referring to FIGS. 3A, 4A-4C, 5A, 5B, and 6, the lift 150 is controlled by a lift controller 199 that is communicably coupled to the control server 120 and/or warehouse management system 2500 in any suitable manner, such as a wired or wireless connection. The lift controller 199 is configured to effect extension and retraction of the end effector 360 at predetermined level(s) 130L of the storage structure 130, and effect lifting and lowering the load handling unit LHD to the predetermined level(s) 130L of the storage structure 130 for transfer of outbound case units CU to the outbound conveyor 160CB (see FIG. 5A) in accordance with a predetermined case out order sequence. For example, the lift(s) 150 may be controlled by the controller 199 to output cases to a respective output station 160UT in a manner substantially similar to that described in U.S. Pat. No. 9,856,083 issued on Jan. 2, 2018; 10, 102, 496 issued on Oct. 16, 2018; U.S. Pat. No. 10,954,066 issued on Mar. 23, 2021; U.S. Pat. No. 10,521,767 issued on Dec. 31, 2019; and U.S. Pat. No. 11,440,746 issued on Sep. 13, 2022, the disclosures of which are incorporated herein by reference in their entireties.

To pick a case unit(s) CU with the lift 150 from material handling system 100 the carriage 350 is moved to predetermined level 130LP from which the case unit(s) CU is to be picked (FIG. 6A). Here, the controller 199 effects operation of the lift drive 150D so that the carriage 350 travels in the Z direction along the rails or tracks 370A, 370B so that the case unit support plane 399 of the end effector 360 of the load handling device LHD is below a case unit support plane TSSP of the transfer station TS (or buffer station BS or transfer arm/end effector of bot 110) (see FIG. 6H and also FIGS. 3A and 6F).

The controller 199 effects control of the end effector drive 365 so that the end effector 360 extends in direction D1A underneath the case unit(s) CU held on the transfer station TS (or buffer station BS or transfer arm/end effector of bot 110) (see FIGS. 6B and 6F). With the end effector 360 of the load handling device LDH disposed underneath the case unit CU, the controller 199 effects movement of the carriage 350 upward in the Z direction so that the end effector 360 lifts the case unit(s) CU from the transfer station TS (or buffer station BS or transfer arm/end effector of bot 110) case unit support plane TSSP so that the case unit(s) CU is transferred from the transfer station TS (or buffer station BS or transfer arm/end effector of bot 110) to the end effector 360 of the load handling device LHD (see FIGS. 6C and 6G). With the case unit(s) supported on the end effector 360, the controller 199 effects operation of the end effector drive 365 to retract the end effector 360 in direction D1B to a fully retracted position onboard the load handling device LHD (FIG. 6D).

With the case unit(s) CU held onboard the load handling device, and with the end effector 360 in the fully retracted position, the controller 199 effects control of the lift drive 150 to move the carriage 350 in the Z direction to another storage level 130L or to a level of an outbound conveyor 160CB (FIG. 6E). Where the case unit(s) CU are transferred to another storage level 130L, the case units CU may be placed into storage a storage space(s) 130S, such as by transfer of the case unit(s) CU by bot(s) 110, or the case unit(s) CU may form a pickface with one or more case units on the other storage level 130L. Here, the transfer of case unit(s) CU to other storage levels 130L may effect sortation of the case unit(s) CU and or balancing distribution of case units between storage levels 130L. It is noted that the placement of a case unit(s) CU to a storage level 130L from the inbound conveyor 160CA may occur in a manner substantially opposite to that described above.

Where the case unit(s) CU are transferred to an outbound conveyor 160CB (or inbound conveyor 160CA), the outbound conveyor 160CB (or inbound conveyor 160CA) may be integrated in the storage structure 130. For example, as can be seen in FIG. 5A, the conveyor 160CA, 160CB is disposed in a stack with the transfer stations TS, where the conveyor 160CA, 160CB is coupled to and supported by one or more of the vertical support members 1212 and horizontal support members 1200. The conveyor 160CA, 160CB may extend along a portion of the storage structure 130 so that the conveyor 160CA, 160CB is common to (i.e., serves all of) the lifts 150 integrated into that portion of the storage structure 130. For example, FIG. 5 illustrates a portion of the storage structure 130 into which the conveyor 160CA, 160CB is integrated. Here, for exemplary purposes only, two lifts 150 (although in other aspects there may be more or less than two lifts) are integrated into the same portion of the storage structure 130 so that each of the lifts 150 access the conveyor 160CA, 160CB for transferring case units CU to and from the conveyor 160CA, 160CB. Here, multiple lifts 150 transporting case units to and from the same conveyor 160CA, 160CB may effect sorting of case units CU in a predetermined case out order sequence in a manner substantially similar to that noted above.

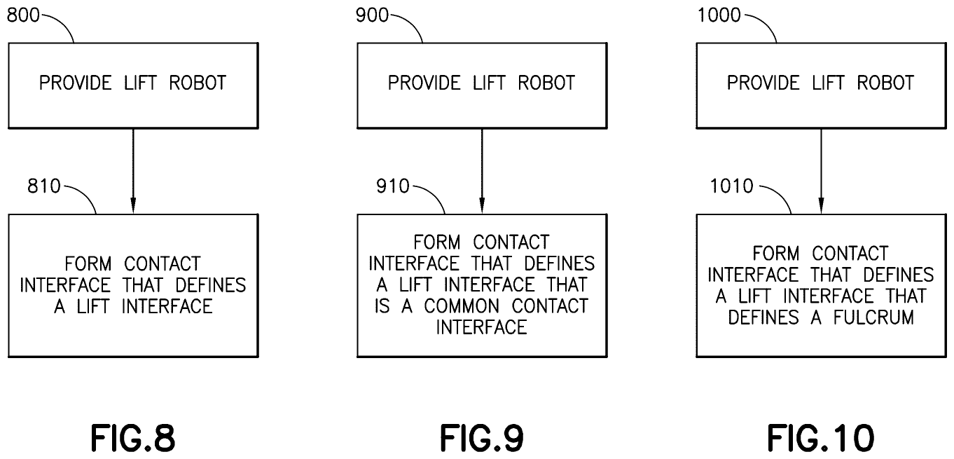

Referring to FIGS. 1, 3A-7B, and 8, an exemplary method will be described in accordance with aspects of the present disclosure. In the method, the load handling device or lift robot LHD is provided (FIG. 8, Block 800), where the load handing device LHD is configured as described herein. The contact interface CINT is formed with the wheel set WST where the contact interface CINT is arranged along a substantially upright plane including the lift axis LAX and the contact interface CINT defines the lift interface engaging the riding surface 371-373 FIG. 8, Block 810), and where the contact interface CINT is maintained substantially continuously throughout the complete range of motion of the load handling device LHD.

Referring to FIGS. 1, 3A-7B, and 9, an exemplary method will be described in accordance with aspects of the present disclosure. In the method, the load handling device or lift robot LHD is provided (FIG. 9, Block 900), where the load handing device LHD is configured as described herein. The contact interface CINT is formed with the wheel set WST, where the contact interface CINT is arranged along a substantially upright plane including the lift axis LAX and the contact interface CINT defines the lift interface engaging the riding surface 371-373 (FIG. 9, Block 910), where the lift interface is a common contact interface between the load handling device LHD and storage rack structure 130 throughout the complete range of motion of the load handling device LHD.

Referring to FIGS. 1, 3A-7B, and 10, an exemplary method will be described in accordance with aspects of the present disclosure. In the method, the load handling device or lift robot LHD is provided (FIG. 10, Block 1000), where the load handing device LHD is configured as described herein. The contact interface CINT is formed with the wheel set WST where the contact interface CINT is arranged along a substantially upright plane including the lift axis LAX and the contact interface CINT defines the lift interface engaging the riding surface 371-373 (FIG. 10, Block 1010), and where the lift interface defines a fulcrum about which the end effector 390 in the extended position generates a moment on the carriage 350 opposing an overturning moment from of the payload bay PLB on the carriage 350.

In accordance with one or more aspects of the present disclosure a lift robot includes: a chassis that defines a lift axis of the lift robot, the chassis has a frame with a wheel set mounted thereon, each wheel of the wheel set contacts a riding surface of a storage rack structure and supports the lift robot on the storage rack structure so that lift robot rides on the storage rack structure throughout a complete range of motion of the lift robot; and a payload bay connected to the chassis, the payload bay having a payload bed, for holding a payload thereon, the payload bed being disposed angled to the lift axis; wherein the wheel set is configured so as to form a contact interface arranged along a substantially upright plane including the lift axis and the contact interface defines a lift interface engaging the riding surface, and wherein the contact interface is maintained substantially continuously throughout the complete range of motion of the lift robot.

In accordance with one or more aspects of the present disclosure the payload bed is substantially orthogonal to the contact interface and the lift axis.

In accordance with one or more aspects of the present disclosure the payload bay cantilevers from the chassis.

In accordance with one or more aspects of the present disclosure the payload bay is arranged so that the payload bed cantilevers substantially orthogonal from the chassis.

In accordance with one or more aspects of the present disclosure the payload bay has an actuated end effector that extends and retracts with respect to the chassis along an extension axis to transfer the payload to and from the lift robot, and the extension axis crosses the lift axis.

In accordance with one or more aspects of the present disclosure the chassis has a substantially upright frame with a longitudinal axis substantially aligned with the lift axis.

In accordance with one or more aspects of the present disclosure the payload bay is on one side of the contact interface, and has a bay longitudinal axis that extends aside and projects from a side of the contact interface.

In accordance with one or more aspects of the present disclosure the payload bay projects aside from but one side of the contact interface in a substantially cantilevered configuration.

In accordance with one or more aspects of the present disclosure a lift robot includes: a chassis that defines a lift axis of the lift robot, the chassis has a frame with a wheel set mounted thereon, each wheel of the wheel set contacts a riding surface of a storage rack structure and supports the lift robot on the storage rack structure so that lift robot rides on the storage rack structure throughout a complete range of motion of the lift robot; and a payload bay connected to the chassis, the payload bay having a payload bed, for holding a payload thereon, the payload bed being disposed angled to the lift axis; wherein the wheel set is configured so as to form a contact interface arranged along a substantially upright plane including the lift axis and the contact interface defines a lift interface engaging the riding surface, and wherein the lift interface is a common contact interface between the lift robot and storage rack structure throughout the complete range of motion of the lift robot.

In accordance with one or more aspects of the present disclosure the payload bed is substantially orthogonal to the contact interface and the lift axis.

In accordance with one or more aspects of the present disclosure the payload bay cantilevers from the chassis.

In accordance with one or more aspects of the present disclosure the payload bay is arranged so that the payload bed cantilevers substantially orthogonal from the chassis.

In accordance with one or more aspects of the present disclosure the payload bay has an actuated end effector that extends and retracts with respect to the chassis along an extension axis to transfer the payload to and from the lift robot, and the extension axis crosses the lift axis.

In accordance with one or more aspects of the present disclosure the chassis has a substantially upright frame with a longitudinal axis substantially aligned with the lift axis.

In accordance with one or more aspects of the present disclosure the payload bay is on one side of the contact interface, and has a bay longitudinal axis that extends aside and projects from a side of the contact interface.

In accordance with one or more aspects of the present disclosure the payload bay projects aside from but one side of the contact interface in a substantially cantilevered configuration.

In accordance with one or more aspects of the present disclosure a lift robot includes: a chassis that defines a lift axis of the lift robot, the chassis has a frame with a wheel set mounted thereon, each wheel of the wheel set contacts a riding surface of a storage rack structure and supports the lift robot on the storage rack structure so that lift robot rides on the storage rack structure throughout a complete range of motion of the lift robot; and a payload bay connected to the chassis, the payload bay having a payload bed, for holding a payload thereon, and an end effector that is actuated between an extended position and a retracted position relative to the chassis to transfer the payload on and off the payload bed; and wherein the wheel set is configured so as to form a contact interface arranged along a substantially upright plane including the lift axis and the contact interface defines a lift interface engaging the riding surface, and wherein the lift interface defines a fulcrum about which the end effector in the extended position generates a moment on the chassis opposing an overturning moment from of the payload bay on the chassis.

In accordance with one or more aspects of the present disclosure the payload bed is disposed angled to the lift axis.

In accordance with one or more aspects of the present disclosure the end effector in the extended position and the payload bay are on opposite sides of the lift interface and the end effector in the extended position substantially balances the payload bay.

In accordance with one or more aspects of the present disclosure the lift robot is mastless, the chassis being arranged to seat onto and engage the riding surface of the storage rack structure so as to define the lift axis mastlessly.

In accordance with one or more aspects of the present disclosure the end effector in the extended position extends along an extension axis from one side of the lift interface, the lift interface being disposed adjacent an end of the end effector in the extended position.

In accordance with one or more aspects of the present disclosure the payload bed is substantially orthogonal to the contact interface and the lift axis.

In accordance with one or more aspects of the present disclosure the payload bay cantilevers from the chassis.

In accordance with one or more aspects of the present disclosure the payload bay is arranged so that the payload bed cantilevers substantially orthogonal from the chassis.

In accordance with one or more aspects of the present disclosure the end effector is actuated along an extension axis, between the extended and retracted positions, that crosses the lift axis.

In accordance with one or more aspects of the present disclosure the chassis has a substantially upright frame with a longitudinal axis substantially aligned with the lift axis.

In accordance with one or more aspects of the present disclosure the payload bay is on one side of the contact interface, and has a bay longitudinal axis that extends aside and projects from a side of the contact interface.

In accordance with one or more aspects of the present disclosure the payload bay projects aside from but one side of the contact interface in a substantially cantilevered configuration.

In accordance with one or more aspects of the present disclosure a method includes: providing a lift robot with: a chassis that defines a lift axis of the lift robot, the chassis has a frame with a wheel set mounted thereon, each wheel of the wheel set contacts a riding surface of a storage rack structure and supports the lift robot on the storage rack structure so that lift robot rides on the storage rack structure throughout a complete range of motion of the lift robot, and a payload bay connected to the chassis, the payload bay having a payload bed, for holding a payload thereon, the payload bed being disposed angled to the lift axis; forming a contact interface with the wheel set where the contact interface is arranged along a substantially upright plane including the lift axis and the contact interface defines a lift interface engaging the riding surface; and wherein the contact interface is maintained substantially continuously throughout the complete range of motion of the lift robot.

In accordance with one or more aspects of the present disclosure the payload bed is substantially orthogonal to the contact interface and the lift axis.

In accordance with one or more aspects of the present disclosure the payload bay cantilevers from the chassis.

In accordance with one or more aspects of the present disclosure the payload bay is arranged so that the payload bed cantilevers substantially orthogonal from the chassis.

In accordance with one or more aspects of the present disclosure the method further includes, with an actuated end effector of the payload bay, extending and retracting the end effector with respect to the chassis along an extension axis to transfer the payload to and from the lift robot, where the extension axis crosses the lift axis.

In accordance with one or more aspects of the present disclosure the chassis has a substantially upright frame with a longitudinal axis substantially aligned with the lift axis.

In accordance with one or more aspects of the present disclosure the payload bay is on one side of the contact interface, and has a bay longitudinal axis that extends aside and projects from a side of the contact interface.

In accordance with one or more aspects of the present disclosure the payload bay projects aside from but one side of the contact interface in a substantially cantilevered configuration.

In accordance with one or more aspects of the present disclosure a method includes: providing a lift robot with: a chassis that defines a lift axis of the lift robot, the chassis has a frame with a wheel set mounted thereon, each wheel of the wheel set contacts a riding surface of a storage rack structure and supports the lift robot on the storage rack structure so that lift robot rides on the storage rack structure throughout a complete range of motion of the lift robot, and a payload bay connected to the chassis, the payload bay having a payload bed, for holding a payload thereon, the payload bed being disposed angled to the lift axis; forming a contact interface with the wheel set where the contact interface is arranged along a substantially upright plane including the lift axis and the contact interface defines a lift interface engaging the riding surface; and wherein the lift interface is a common contact interface between the lift robot and storage rack structure throughout the complete range of motion of the lift robot.

In accordance with one or more aspects of the present disclosure the payload bed is substantially orthogonal to the contact interface and the lift axis.

In accordance with one or more aspects of the present disclosure the payload bay cantilevers from the chassis.

In accordance with one or more aspects of the present disclosure the payload bay is arranged so that the payload bed cantilevers substantially orthogonal from the chassis.

In accordance with one or more aspects of the present disclosure the method further includes, with an actuated end effector of the payload bay, extending and retracting the end effector with respect to the chassis along an extension axis to transfer the payload to and from the lift robot, where the extension axis crosses the lift axis.

In accordance with one or more aspects of the present disclosure the chassis has a substantially upright frame with a longitudinal axis substantially aligned with the lift axis.

In accordance with one or more aspects of the present disclosure the payload bay is on one side of the contact interface, and has a bay longitudinal axis that extends aside and projects from a side of the contact interface.

In accordance with one or more aspects of the present disclosure the payload bay projects aside from but one side of the contact interface in a substantially cantilevered configuration.

In accordance with one or more aspects of the present disclosure a method includes: providing a lift robot having: a chassis that defines a lift axis of the lift robot, the chassis has a frame with a wheel set mounted thereon, each wheel of the wheel set contacts a riding surface of a storage rack structure and supports the lift robot on the storage rack structure so that lift robot rides on the storage rack structure throughout a complete range of motion of the lift robot, and a payload bay connected to the chassis, the payload bay having a payload bed, for holding a payload thereon, and an end effector that is actuated between an extended position and a retracted position relative to the chassis to transfer the payload on and off the payload bed; and forming a contact interface with the wheel set where the contact interface is arranged along a substantially upright plane including the lift axis and the contact interface defines a lift interface engaging the riding surface; and wherein the lift interface defines a fulcrum about which the end effector in the extended position generates a moment on the chassis opposing an overturning moment from of the payload bay on the chassis.

In accordance with one or more aspects of the present disclosure the payload bed is disposed angled to the lift axis.

In accordance with one or more aspects of the present disclosure the end effector in the extended position and the payload bay are on opposite sides of the lift interface and the end effector in the extended position substantially balances the payload bay.

In accordance with one or more aspects of the present disclosure the lift robot is mastless, and the chassis is arranged to seat onto and engage the riding surface of the storage rack structure so as to define the lift axis mastlessly.

In accordance with one or more aspects of the present disclosure the end effector in the extended position extends along an extension axis from one side of the lift interface, and the lift interface is disposed adjacent an end of the end effector in the extended position.

In accordance with one or more aspects of the present disclosure the payload bed is substantially orthogonal to the contact interface and the lift axis.

In accordance with one or more aspects of the present disclosure the payload bay cantilevers from the chassis.

In accordance with one or more aspects of the present disclosure the payload bay is arranged so that the payload bed cantilevers substantially orthogonal from the chassis.

In accordance with one or more aspects of the present disclosure the end effector is actuated along an extension axis, between the extended and retracted positions, that crosses the lift axis.

In accordance with one or more aspects of the present disclosure the chassis has a substantially upright frame with a longitudinal axis substantially aligned with the lift axis.

In accordance with one or more aspects of the present disclosure the payload bay is on one side of the contact interface, and has a bay longitudinal axis that extends aside and projects from a side of the contact interface.

In accordance with one or more aspects of the present disclosure the payload bay projects aside from but one side of the contact interface in a substantially cantilevered configuration.

It should be understood that the foregoing description is only illustrative of the aspects of the present disclosure. Various alternatives and modifications can be devised by those skilled in the art without departing from the aspects of the present disclosure. Accordingly, the aspects of the present disclosure are intended to embrace all such alternatives, modifications and variances that fall within the scope of the appended claims. Further, the mere fact that different features are recited in mutually different dependent or independent claims does not indicate that a combination of these features cannot be advantageously used, such a combination remaining within the scope of the aspects of the invention.

What is claimed is:

1. A lift robot comprising:
a chassis that defines a lift axis of the lift robot, the chassis has a frame with a wheel set mounted thereon, each wheel of the wheel set contacts a riding surface of a storage rack structure and supports the lift robot on the storage rack structure so that lift robot rides on the storage rack structure throughout a complete range of motion of the lift robot; and
a payload bay connected to the chassis, the payload bay having a payload bed, for holding a payload thereon, the payload bed being disposed angled to the lift axis;
wherein the wheel set is configured so as to form a contact interface arranged along a substantially upright plane including the lift axis and the contact interface defines a lift interface engaging the riding surface, and
wherein the contact interface is maintained substantially continuously throughout the complete range of motion of the lift robot.

2. The lift robot of claim 1, wherein the payload bed is substantially orthogonal to the contact interface and the lift axis.

3. The lift robot of claim 1, wherein the payload bay cantilevers from the chassis.

4. The lift robot of claim 1, wherein the payload bay is arranged so that the payload bed cantilevers substantially orthogonal from the chassis.

5. The lift robot of claim 1, wherein the payload bay has an actuated end effector that extends and retracts with respect to the chassis along an extension axis to transfer the payload to and from the lift robot, and the extension axis crosses the lift axis.

6. The lift robot of claim 1, wherein the chassis has a substantially upright frame with a longitudinal axis substantially aligned with the lift axis.

7. The lift robot of claim 1, wherein the payload bay is on one side of the contact interface, and has a bay longitudinal axis that extends aside and projects from a side of the contact interface.

8. The lift robot of claim 1, wherein the payload bay projects aside from but one side of the contact interface in a substantially cantilevered configuration.

9. A lift robot comprising:
a chassis that defines a lift axis of the lift robot, the chassis has a frame with a wheel set mounted thereon, each wheel of the wheel set contacts a riding surface of a storage rack structure and supports the lift robot on the storage rack structure so that lift robot rides on the storage rack structure throughout a complete range of motion of the lift robot; and
a payload bay connected to the chassis, the payload bay having a payload bed, for holding a payload thereon, the payload bed being disposed angled to the lift axis;
wherein the wheel set is configured so as to form a contact interface arranged along a substantially upright plane including the lift axis and the contact interface defines a lift interface engaging the riding surface, and
wherein the lift interface is a common contact interface between the lift robot and storage rack structure throughout the complete range of motion of the lift robot.

10. The lift robot of claim 9, wherein the payload bed is substantially orthogonal to the contact interface and the lift axis.

11. The lift robot of claim 9, wherein the payload bay cantilevers from the chassis.

12. The lift robot of claim 9, wherein the payload bay is arranged so that the payload bed cantilevers substantially orthogonal from the chassis.

13. The lift robot of claim 9, wherein the payload bay has an actuated end effector that extends and retracts with respect to the chassis along an extension axis to transfer the payload to and from the lift robot, and the extension axis crosses the lift axis.

14. The lift robot of claim 9, wherein the chassis has a substantially upright frame with a longitudinal axis substantially aligned with the lift axis.

15. The lift robot of claim 9, wherein the payload bay is on one side of the contact interface, and has a bay longitudinal axis that extends aside and projects from a side of the contact interface.

16. The lift robot of claim 9, wherein the payload bay projects aside from but one side of the contact interface in a substantially cantilevered configuration.

17. A lift robot comprising:
a chassis that defines a lift axis of the lift robot, the chassis has a frame with a wheel set mounted thereon, each wheel of the wheel set contacts a riding surface of a storage rack structure and supports the lift robot on the storage rack structure so that lift robot rides on the storage rack structure throughout a complete range of motion of the lift robot; and
a payload bay connected to the chassis, the payload bay having a payload bed, for holding a payload thereon, and an end effector that is actuated between an extended position and a retracted position relative to the chassis to transfer the payload on and off the payload bed; and
wherein the wheel set is configured so as to form a contact interface arranged along a substantially upright plane including the lift axis and the contact interface defines a lift interface engaging the riding surface, and
wherein the lift interface defines a fulcrum about which the end effector in the extended position generates a moment on the chassis opposing an overturning moment from of the payload bay on the chassis.

18. The lift robot of claim 17, wherein the payload bed is disposed angled to the lift axis.

19. The lift robot of claim 17, wherein the end effector in the extended position and the payload bay are on opposite sides of the lift interface and the end effector in the extended position substantially balances the payload bay.

20. The lift robot of claim 17, wherein the lift robot is mastless, the chassis being arranged to seat onto and engage the riding surface of the storage rack structure so as to define the lift axis mastlessly.

21. The lift robot of claim 17, wherein the end effector in the extended position extends along an extension axis from one side of the lift interface, the lift interface being disposed adjacent an end of the end effector in the extended position.

22. The lift robot of claim 17, wherein the payload bed is substantially orthogonal to the contact interface and the lift axis.

23. The lift robot of claim 17, wherein the payload bay cantilevers from the chassis.

24. The lift robot of claim 17, wherein the payload bay is arranged so that the payload bed cantilevers substantially orthogonal from the chassis.

25. The lift robot of claim 17, wherein the end effector is actuated along an extension axis, between the extended and retracted positions, that crosses the lift axis.

26. The lift robot of claim 17, wherein the chassis has a substantially upright frame with a longitudinal axis substantially aligned with the lift axis.

27. The lift robot of claim 17, wherein the payload bay is on one side of the contact interface, and has a bay longitudinal axis that extends aside and projects from a side of the contact interface.

28. The lift robot of claim 17, wherein the payload bay projects aside from but one side of the contact interface in a substantially cantilevered configuration.
